(19) United States
(12) Patent Application Publication
(10) Pub. No.: US 2013/0215599 A1
(43) Pub. Date: Aug. 22, 2013

(54) LIGHTING DEVICES WITH COLOR-TUNING MATERIALS AND METHODS FOR TUNING COLOR OUTPUT OF LIGHTING DEVICES

(71) Applicants: James Lynn Davis, Holly Springs, NC (US); Kimberly A. Guzan, Clayton, NC (US)

(72) Inventors: James Lynn Davis, Holly Springs, NC (US); Kimberly A. Guzan, Clayton, NC (US)

(73) Assignee: RESEARCH TRIANGLE INSTITUTE, INTERNATIONAL, RESEARCH TRIANGLE PARK, NC (US)

(21) Appl. No.: 13/817,900

(22) PCT Filed: Aug. 19, 2011
(86) PCT No.: PCT/US2011/048440

§ 371 Date: May 8, 2013

Related U.S. Application Data
(60) Provisional application No. 61/375,568, filed on Aug. 20, 2010.

(51) Int. Cl. F21V 9/10

(52) U.S. Cl. CPC F21V 9/10
USPC 362/84

(57) ABSTRACT

A lighting device may include a housing interior, a light exit, a light source, and a light converter. Output light is outputted from the light exit by emitting primary light from the light source. In response, the light converter emits secondary light of one or more wavelengths different than the primary wavelength, and the output light includes a combination of the primary light and the secondary light. The color of the output light may be tuned by adjusting a color parameter of the output light. The adjustment includes adding a color tuning material at a location in the housing interior where primary light is incident on the color tuning material. The color tuning material is configured for emitting auxiliary light in response to the incident primary light. Subsequently, the lighting device produces color-tuned output light that includes a combination of the primary light, the secondary light and the auxiliary light.

### RELATED APPLICATIONS

This application claims the benefit of U.S. Provisional Patent Application Ser. No. 61/375,568, filed Aug. 20, 2010, titled “LIGHTING DEVICES WITH COLOR-TUNING MATERIALS AND METHODS FOR TUNING COLOR OUTPUT OF LIGHTING DEVICES;” the content of which is incorporated by reference herein in its entirety.

### FEDERALLY SPONSORED SUPPORT

This invention was made with government support under Award No. DE-FC26-06NT42861 by the U.S. Department of Energy. The United States Government may have certain rights in the invention.

### TECHNICAL FIELD

The present invention relates generally to lighting devices. In particular, the invention relates to adjusting the color of light produced by a lighting device.

### BACKGROUND

For general purpose illumination requiring white light, solid-state lighting (SSL) devices are being investigated as alternatives to conventional lighting devices such as incandescent and fluorescent lighting devices. Incandescent lighting (IL) devices emit white light by thermal radiation from a hot, electrically resistive filament. The spectral quality and color-rendering accuracy of incandescent light is high, approaching the performance of an ideal black-body radiator. However, incandescent lighting suffers from very low energy efficiency and operating lifetimes, with most of the energy input being converted to heat rather than useful emission of visible light. Fluorescent lighting (FL) devices emit white light from phosphor-coated surfaces in response to irradiation of those surfaces by ultraviolet (UV) light generated from energized mercury vapor. Fluorescent lighting is more energy efficient and has higher operating lifetimes, but typically has poor spectral quality. Moreover, incandescent and fluorescent lighting require light bulbs that must remain sealed to maintain a vacuum or contain a gas, respectively, and are prone to breaking.

On the other hand, SSL devices do not require sealed bulbs, have robust designs that do not require flexible or fragile components, and are highly energy efficient. SSL devices typically utilize LED lamps that produce light in narrow ranges of wavelengths (e.g., red, green or blue). White light-emitting SSL devices have been provided in two different configurations. In one configuration, the white light-emitting SSL device utilizes a closely-spaced cluster of red, green and blue LEDs to produce white light from the spectral composite of emissions from the LEDs. This “RGB LED” configuration enables the color of the white light to be adjusted if the associated electronic circuitry is configured to enable adjustment of drive currents provided to (and thus adjustment of the intensities of) the individual LEDs. However, a high cost is associated with the provision of multiple LEDs and complex drive circuitry. In another configuration, the SSL device utilizes a blue or UV LED packaged with one or more phosphors for converting the short-wavelength emission from the LED to longer-wavelength emissions, whereby white light is produced from the mixture of emissions in a manner similar to fluorescent lighting. Compared to RGB LED devices, the phosphor-converted LED approach is lower in cost but does not provide any means for adjusting the color of the white light. Consequently, color rendering index (CRI) values are low for phosphor-converted LED-based lighting devices. Generally, conventional SSL lighting devices of any type typically exhibit CRI values of less than 80.

Because the human eye is very sensitive to small variations in color, the end user can sometimes detect variations in correlated color temperature (CCT) as small as 10-20 K. Hence, lighting devices must be held to tight specifications to avoid noticeable color variation in large installations. Variations in CCT and CRI typically arise in SSL lamps due to manufacturing variability and are manifested as visible color variations in lighting devices equipped with SSL lamps. Currently, there is no economical way to manufacture a large number of white lighting devices that output the same character (e.g., tone, hue, etc.) of white color. There is also no practical way to adjust output color of a lighting device once it has been manufactured. Consequently, a batch of manufactured SSL devices must be screened at the end of the manufacturing line (end of line, or EOL) and sorted into bins according to CCT, CRI and other properties. This process is known as “binning” and results in all lighting devices of a given bin having approximately the same color. Different bins may then be provided to different customers or for different lighting installation projects. Binning is disadvantageous because it adds time, effort and cost to the manufacturing process. Moreover, binning is an imperfect solution to the problem of color variation. Binning does not correct color variation but rather separates lighting devices with similar colors into different groups. Moreover, the variation in color among the lighting devices of a given bin may still be noticeable. For instance, a bin of lighting devices may be provided to a customer who then installs them as lighting fixtures in the ceiling of a large meeting room. Different persons in different areas of the room may notice non-uniformities in the light provided by the lighting fixtures due to the inadequacy of the binning process.

In addition, an end user may wish to adjust the tone or hue of the color provided by a lighting device. For example, in the case of a white lighting device the user may desire to adjust whether white light is warm (yellowish or reddish, e.g., CCT=2,600-3,700 K), neutral (e.g., CCT=3,700-5,000 K), or cool (bluish, e.g., CCT=5,000-10,000 K) for specific purposes such as general lighting in a relaxing environment, general lighting in an office environment, lighting for reading, etc. Also, the end user may be using a lighting device containing multiple lighting device units with respective SSL sources and light exits, or multiple lighting devices installed in the same location. In these latter cases, the end user may wish to adjust one or more lighting device units of a single lighting device, or one or more lighting devices grouped in close proximity, so that the light outputted by all lighting devices or lighting device units is uniform.

In view of the foregoing, there is a need for adjusting the color (or one or more color properties) of light produced by a lighting device. As noted above, the need for adjusting color may arise in the field by an end user or at the EOL by a manufacturer.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, a lighting device includes a housing, a light source, a light converter, and a color tuning material. The housing encloses a housing interior and includes a light exit for outputting a combination of primary light, secondary light, and auxiliary light. The light source is configured for emitting a primary light beam of a primary wavelength through the housing interior. The light converter includes a luminescent material facing the housing interior. The luminescent material is configured for emitting secondary light of one or more wavelengths different from the primary wavelength, in response to excitation by the primary light beam. The color tuning material is optically aligned with the light source and configured for emitting auxiliary light in response to incidence by the primary light beam.

In some implementations, the added color tuning material is or includes one or more luminescent materials, a reflective material, or both luminescent and reflective materials.

In some implementations, the reflective material is barium sulfate, titanium (IV) oxide, alumina, zinc oxide, and/or PTFE.

In some implementations, the added color tuning material is or includes a luminescent material configured for emitting the auxiliary light at a wavelength equal to at least one wavelength of the secondary light.

In some implementations, the added color tuning material is or includes a luminescent material configured for emitting the auxiliary light at a wavelength different from at least one wavelength of the secondary light.

In some implementations, the added color tuning material is or includes a luminescent material such as quantum dots, phosphors, nano-phosphors, organic dyes, or combinations of two or more of the foregoing.

In some implementations, the added color tuning material is or includes a luminescent material such as a red emitter, orange emitter, yellow emitter, green emitter, blue emitter, or combinations of two or more of the foregoing.

In some implementations, the color tuning material is supported by a substrate. In some implementations, the substrate is a reflective substrate such as a metal, a metal-inclusive compound, a metal-inclusive alloy, a ceramic, a glass, a polymer, a cellulosic material, or a non-woven mat.

In some implementations, the color tuning material includes a plurality of color tuning material units positioned at different locations in the housing interior.

In some implementations, the luminescent material of the light converter includes two or more luminescent components configured for emitting secondary light components of two or more different wavelengths.

In various implementations, the light source may be a blue light source, a violet light source, an ultraviolet light source, or a white light source.

According to another implementation, a method is provided for tuning a color of light produced by a lighting device. The lighting device includes a housing interior, a light exit, a light source, and a light converter. Output light is outputted from the light exit by emitting primary light of a primary wavelength from the light source through the housing interior. The light converter emits secondary light through the housing interior at one or more wavelengths different than the primary wavelength, in response to excitation by the primary light. The output light includes a combination of the primary light and the secondary light. A color parameter of the output light is adjusted by adding a color tuning material at a location in the housing interior where primary light is incident on the color tuning material. The color tuning material is configured for emitting auxiliary light in response to the incident primary light, wherein subsequent operation of the lighting device produces color-tuned output light that includes a combination of the primary light, the secondary light and the auxiliary light.

In some implementations, the color parameter is color rendering index. After adjustment, the color-tuned output light may have a color rendering index of 50 or greater.

In some implementations, the color parameter is correlated color temperature. After adjustment, the outputting color-tuned output light may have a correlated color temperature ranging from 2,500 to 5,500 K.

In some implementations, the color parameter is distance from Plankian locus. After adjustment, the color-tuned output light may have chromaticity coordinates closer to the Plankian locus than the output light before the adjustment.

According to another implementation, a method is provided for tuning a color of light produced by a lighting device. The lighting device includes a housing interior, a light exit, a light source, and a light converter. An evaluation is made of output light emanating from the light exit. The output light is produced by emitting primary light of a primary wavelength from the light source through the housing interior, wherein the light converter emits secondary light through the housing interior in response to excitation by the primary light. The secondary light has one or more wavelengths different than the primary wavelength. The output light comprises a combination of the primary light and the secondary light. A determination is made as to whether the color of the output light should be tuned. If it is determined that the color of the output light should be tuned, a color tuning material is added at a location in the housing interior where primary light is incident on the color tuning material. The color tuning material is configured for emitting auxiliary light in response to the incident primary light. After tuning the color, the lighting device produces color-tuned output light in which the auxiliary light is combined with the primary light and the secondary light.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1A is a perspective view of an example of a lighting device according to the present teachings.

FIG. 1B is a cross-sectional view of another example of a lighting device according to the present teachings.

FIG. 2 is a set of angular emission profiles produced by an LED in which illumination intensity is plotted as a function of angle from the nominal output axis, for three different LED drive currents.

FIG. 3A is a plan view of an example of a light converter and a color tuning material applied to the light converter according to the present teachings.

FIG. 3B is a side view of an example of a lighting device that includes the light converter and color tuning material illustrated in FIG. 3B.

FIG. 4A is a plan view of the light converter illustrated in FIG. 3A with the color tuning material applied at a different location.

FIG. 4B is a top view of an example of a lighting device that includes the light converter and color tuning material illustrated in FIG. 4A.

FIG. 5 is a plan view of the light converter illustrated in FIG. 3A with the color tuning material applied so as to overlap two different types of luminescent materials of the light converter.

FIG. 6 is a side view of a portion of the light converter illustrated in FIG. 3A, and an example of a substrate-based color tuning material applied to the light converter.

FIG. 7 is a side view of an example of a lighting device in which two color tuning materials have been added to respective areas of an inside surface of the lighting device, according to the present teachings.

FIG. 8 is a side view of an example of a lighting device in which a color tuning material is added by supporting the color tuning material at one or more locations, according to the present teachings.

FIG. 9 is a side view of an example of a lighting device in which a color tuning material is added to a pre-embedded substrate or a pre-designated location of the lighting device, according to the present teachings.

FIG. 10 is a set of data indicating spectral radiant flux as a function of wavelength after three successive iterations of adding a color tuning material to a prototype lighting device performed according to the present teachings.

FIG. 11 is a representation of a CIE 1931 (x,y) chromaticity diagram illustrating the effects of adding a color tuning material to a lighting device according to the present teachings.

FIG. 12 is a flow diagram illustrating a method for tuning a color of output light produced by a lighting device according to the present teachings.

FIG. 13A is a schematic view of an example of a fiber supporting reflective or luminescent particles according to the present teachings.

FIG. 13B is a schematic view of another example of a fiber supporting reflective or luminescent particles according to the present teachings.

FIG. 14 is a schematic view of a nanofiber substrate formed with the fibers illustrated in FIG. 13A and/or FIG. 13B according to the present teachings.

FIG. 15 provides reflectance data measured as a function of wavelength for four samples of nanofiber substrates of different thicknesses.

### DETAILED DESCRIPTION

As used herein, the term “nanofiber” refers to a typically solid structure that has one dimension (e.g., diameter) in the 10-5000 nm range, while the other dimension (e.g., length) may be quite long such as on the order of meters. Nanofibers may be made from a variety of materials, including polymers, ceramics, glasses, and sol gels, and blends of materials may also be readily fabricated. One feature of nanofibers is their small diameter relative to their length and consequently high surface area and aspect ratio (length:diameter). Nanofiber diameters on the order of visible light (about 380-760 nm) or even smaller may be readily produced, thereby creating very large surface areas.

As used herein, the term “luminescent particle” or “light-stimulable particle” refers generally to any photoluminescent (PL) particle. In typical implementations, the luminescent particles are capable of forming a composite with a suitable substrate, which may be amorphous, (poly)crystalline, or fibrous. As examples, the luminescent particles may be provided as one or more layers or regions on the substrate, as a distribution embedded in the substrate, as an interpenetrating network in the substrate, or as a distribution supported on or in fibers of the substrate. Examples of luminescent particles include quantum dots, phosphors, nano-phosphors, and organic dyes. While some luminescent particles may exhibit luminescent behavior by other mechanisms (e.g., electroluminescence), typical implementations taught herein rely principally on the photoluminescent response of particles. Accordingly, for convenience the terms “luminescent” and “PL” will be used interchangeably in the present disclosure in the context of particles or related materials that exhibit photoluminescence, without intending to exclude other types of luminescent activity.

As used herein, the term “quantum confined semiconductor particle” or “quantum dot” (QD) refers to a semiconductor nanocrystal-based material in which excitons are confined in all three spatial dimensions, as distinguished from quantum wires (quantum confinement in only two dimensions), quantum wells (quantum confinement in only one dimension), and bulk semiconductors (unconfined). A quantum dot may generally be characterized as a particle, the shape of which may be spherical, cylindrical, ellipsoidal, polygonal, or other shape. The “size” or “particle size” of the quantum dot may refer to a dimension characteristic of its shape or an approximation of its shape, and thus may be a diameter, a major axis, a predominant length, etc. The size of a quantum dot is on the order of nanometers, generally ranging from 1-1000 nm, but more typically ranging from 1-100 nm, 1-50 nm, 1-20 nm, or 1-10 nm. In a plurality or ensemble of quantum dots, the quantum dots may be characterized as having an average size. The size distribution of a plurality of quantum dots may or may not be monodisperse, but in some implementations may preferably be monodisperse through controlled synthesis so as to provide consistent light emission. The quantum dot may have a core-shell configuration, in which the nanocrystalline core and surrounding shell may have distinct compositions. The shell is typically an inorganic compound with a higher band gap than the core material. The shell may serve a function such as, for example, chemically stabilizing the core, isolating the core from the environment, etc. The optical properties of core-shell quantum dots are typically determined by their core. The quantum dot may also be capped with ligands attached to its outer surface (core or shell) or may otherwise be functionalized with certain chemical moieties for a specific purpose, such as providing compatibility with a solvent, serving as a surfactant to promote solution and prevent agglomeration, etc. Agglomeration may be disadvantageous for a number of reasons, including altering the emission characteristics to a degree noticeable by the human eye.

Quantum dots are advantageous because they function at temperatures that do not require an associated lighting device to provide temperature controlling means. Moreover, quantum dots may be produced utilizing relatively low-cost and easily implemented processing techniques, such as in the case of solution-processed colloidal quantum dots. Furthermore, the quantum confinement results in many optical, electrical and chemical properties of the quantum dot (e.g., band gap) being strongly dependent on its size, and hence such properties may be modified or tuned by controlling the size of the quantum dot during synthesis. For example, two quantum dots having the same composition but different sizes may respectively emit photons at different wavelengths in response to the same stimulus. Generally, for many quantum dot compositions smaller sizes emit radiation at shorter wavelengths and larger sizes emit radiation at longer wavelengths. Some properties may also depend on the shape of the quantum dot. Accordingly, a combination of different quantum dots (different as to composition, size and/or shape) may be provided in a PL material to provide secondary light emission at two or more different wavelengths. Different quantum dots may be distributed as a mixture or may be partitioned into separate regions or zones on or in a substrate. Partitioning may be preferable for preventing absorption by one type of quantum dot of a photon emitted by another type of quantum dot, and/or for facilitating the color tuning techniques described below.

As used herein, the term “phosphor” refers to a luminescent particle typically composed of an inorganic host material (e.g., aluminum garnet, metal oxides, metal nitrides, metal oxynitrides, metal sulfides, metal selenides, metal halides, or metal silicates) that includes an activator (e.g., copper, silver, europium, cerium or other rare earth metals). Typically, the activator is added as a dopant. Within the host material, the activators function as centers of luminescent emission. Typically, the size of a phosphor particle is 1 μm or greater. The term “nano-phosphor” refers to a phosphor having a particle size of 100 nm or less. Nano-phosphors often have similar chemistries as the larger-size phosphors but scatter light to a lesser degree due to their smaller size. As nano-particles, nano-phosphors may have various attributes similar to those of quantum dots.

As used herein, the term “reflective” means that a given material (whether a surface or a bulk region of the material) reflects greater than 80% of incident light of a given wavelength or wavelengths. The term “transparent” or “light-transmitting” means that a given material is able to efficiently pass greater than 50% of incident light of a given wavelength or wavelengths. Unless specified otherwise, the term “transparent” or “light-transmitting” encompasses the terms “partially transparent” and “translucent.”

For purposes of the present disclosure, the spectral ranges or bands of electromagnetic radiation are generally taken as follows, with the understanding that adjacent spectral ranges or bands may be considered to overlap with each other to some degree: Ultraviolet (UV) radiation spans the range of about 10-400 nm, although in practical applications (above vacuum) the range is about 200-400 nm Visible radiation spans the range of about 380-760 nm. Violet radiation spans the range of about 400-450 nm. Blue radiation spans the range of about 450-490 nm. Green radiation spans the range of about 490-560 nm Yellow radiation spans the range of about 560-590 nm. Orange radiation spans the range of about 590-635 nm. Red radiation spans the range of about 635-700 nm.

In the present context, the term “color” refers to the appearance of emitted light as perceived by the human eye. Color may be described by a measurable property (or “color parameter”) of the light such as, for example, color rendering index (CRI), correlated color temperature (CCT), chromaticity coordinates (x,y), (u,v) or (u′,v′), and distance from Plankian locus (Dᵤᵥ), as may be defined by CIE (International Commission on Illumination) standards. The CRI is a measure of the ability of a white light source to faithfully reproduce the color appearance of objects in comparison to a reference light source such as a black-body radiator or daylight. The general color rendering index adopted by CIE, designated Rₐ, is typically utilized. The CRI of an ideal reference source having a balanced spectral power distribution (SPD) is defined as 100. Hence, high CRI values are desirable for actual light sources, for example greater than 80 for interior lighting. The color temperature of a light source emitting light of a given hue corresponds to the temperature (in degrees Kelvin) of an ideal black-body radiator emitting light of a comparable hue. However, black-body radiators emit light by thermal radiation while light sources such as SSL lamps primarily emit light by non-thermal mechanisms. Therefore, for these types of light sources a correlated value (CCT) is utilized as an approximation. Higher color temperatures (5,000K and above) are termed “cool” colors and appear bluish, while lower color temperatures (2,700-3,000K) are termed “warm” colors and appear yellowish to reddish. Intermediate color temperatures may be termed “neutral” colors. Warmer colors are often utilized for illuminating public areas to promote relaxation, while cooler colors are often utilized in office areas to promote concentration. All color temperatures visible to the average human eye (i.e., the gamut of human vision) may be shown, in color, in the color space of the CIE 1931 (x,y) chromaticity diagram (see, e.g., FIG. 11), the CIE 1960 (u,v) uniform chromaticity space (UCS) diagram, or the CIE 1976 (u′,v′) uniform chromaticity scale (UCS) diagram. Except for brightness, a color may be described by its chromaticity, i.e., its x-y or u-v coordinate position on a chromaticity diagram. A chromaticity diagram may also show the Planckian locus, which is the path taken through the color space by a black-body radiator as its temperature changes. In a direction from lower to higher color temperature, the Planckian locus runs from deep red through orange, yellowish white and white, to bluish white. The distance of a color's coordinate position from the Planckian locus may be utilized to calculate CRI and CCT. The CIE (u,v) or (u′,v′) diagram is typically utilized to calculate distance from the Planckian locus. CIE (x,y) coordinates may be converted to CIE (u,v) or (u′,v′), coordinates utilizing known transformations.

As described by way of examples below, lighting devices (i.e., luminaires or light fixtures) are provided with color tuning materials that adjust or tune the color of the light produced by the lighting devices. In addition, apparatus and methods are provided for adjusting or tuning the color of light outputted from a lighting device. A color tuning material may also be referred to as a “light adjusting material.” Light outputted from a lighting device will be referred to as “output light.” The color tuning techniques disclosed herein may be utilized to adjust the color of the output light by adjusting values of one or more color parameters such as, for example, spectral power distribution (SPD), CRI, CCT, chromaticity coordinates, and distance from Plankian locus. Color tuning may be done for any purpose. As examples, an end user may desire to adjust the output of a single lighting device (e.g., to render white light warmer, cooler, or more neutral) or, in the case of a set of lighting devices, to adjust the output of one or more of the lighting devices to achieve a consistent appearance from the lighting devices. As another example, a manufacturer may desire to adjust one or more lighting devices at the end of the manufacturing line (EOL) to reduce or eliminate any variability in light output from a batch of manufactured lighting devices.

In some implementations taught in the present disclosure, a lighting device includes one or more primary light sources, one or more light converters (or “secondary converters”), a housing, and one or more color tuning materials. The lighting device may also include one or more reflective materials (or reflectors). Examples of color tuning materials and methods for adding them to the lighting device are described below.

The primary light source may be any suitable light source for generating a beam of primary light (or excitation light, or pump light) and directing the beam through an interior of the housing toward the light converter. In this context, primary light is electromagnetic radiation propagating at any desired wavelength (visible or non-visible) that is sufficient to induce emission from the light converter of electromagnetic radiation at one or more wavelengths different from the primary (or excitation, or pump) wavelength and within the visible spectrum. This type of emission will be referred to as secondary light or secondary emission. In typical implementations, the primary light source is configured for emitting radiation of relatively short wavelengths such as UV, violet or blue. No specific limitation is placed on the type of primary light source, although in typical examples the primary light source is an electroluminescent (EL) device such as a laser diode (LD) or more typically a light-emitting diode (LED). In the context of lighting applications, an EL device may be referred to as a solid-state lighting (SSL) lamp or SSL device. An LED (or other EL device) may be based on a conventional system of inorganic semiconductor materials such as Group III (In, Al, Ga) nitrides, or may be an organic LED (OLED), a polymer LED (PLED), or a hybrid design utilizing both inorganic and organic components.

The light converter may be any luminescent material, or any structure that includes a luminescent material, capable of emitting secondary light in response to excitation by the incident primary light beam. As noted above, the luminescent material is typically a photoluminescent (PL) material. Typically, emission of secondary light from a PL material occurs through the mechanism of fluorescence. Depending on the type of PL material utilized, the secondary wavelength may be shorter or longer than the primary wavelength. Typically, the PL material is configured to emit a longer wavelength as short-wavelength light sources are readily available and shorter-to-longer wavelength conversions tend to be more efficient. The PL material may include two or more different types of PL materials configured to emit secondary light at two or more respective wavelengths in response to excitation by the incident primary light beam. For example, the PL material may include both red-emitting and green-emitting materials, which in some implementations may be utilized in conjunction with a blue, violet or UV light source to produce white light. In some implementations, the PL material includes a plurality of luminescent (or light-stimulable) particles supported by a substrate. In this context, “supported by” means that the luminescent particles are encapsulated or embedded in the substrate and/or disposed on the substrate in a stable manner. The luminescent particles may be QDs, phosphors, nano-phosphors, organic dyes, or a combination of two of more of the foregoing. Color parameters such as CCT may be controlled by controlling the quantity of luminescent particles over a unit area of the PL material (i.e., density), the thickness of a layer of luminescent particles, the composition of the luminescent particles, etc. Different types of luminescent particles may be utilized simultaneously. As one example, a PL material may include one or more sections of green-emitting nano-phosphors and one or more sections of red-emitting QDs. Different sections of different PL materials may be spatially separated from each other to limit secondary absorption. Additionally, the light converter may include a reflective material, examples of which are described below.

In various implementations, the light converter may be positioned remotely from the light source. By this configuration, luminescence occurs over a large surface area resulting in improved uniformity in color, and thermal degradation by heat generated from the light source is reduced or eliminated. The light converter may be rigid or flexible.

The substrate of the PL material may be selected based on its light-transmission and/or light-reflection properties. Examples of substrates include, but are not limited to, various polymers, ceramics, glasses, and natural and synthetic papers such as PolyArt® papers or other types of cellulosic materials. Light reflection may be imparted to certain types of substrates by introducing features with dimensions on the order to the wavelength of light. Such features, typically 100 nm to 800 nm in size, promote scattering of a light beam thereby increasing the reflection coefficient. Examples include etched glasses and polymers. In some implementations, the PL material is a photoluminescent nanofiber (PLN) structure that includes one or more types of luminescent particles supported on a substrate formed from nanofibers (e.g., a nonwoven mat), as described in more detail below.

The housing generally may be any structure suitable for containing visible electromagnetic radiation during optical processing of the radiation by the lighting device and prior to output of the radiation from the lighting device. In particular, the housing may be any structure that provides an interior or cavity suitable for mixing (or combining) primary light components and secondary light components, and a light exit or aperture through which the mixed (or composite) light emanates to the ambient environment outside the lighting device. Additionally, the housing may serve as a structure for mounting or supporting one or more other components of the lighting device. The light exit may be an uncovered opening or may include a light-transmitting structure that spans the opening. The light-transmitting structure may serve to protect components residing in the housing interior from the ambient environment. Additionally, the light-transmitting structure may be or include an optical component configured to perform an optical processing function on the output light, such as promoting the mixing or diffusion of the primary and second light components, focusing the output light as a beam (e.g., a lens), etc. It will be noted that lighting devices as taught herein do not require color filters.

A reflective material may be mounted in a suitable location in the housing interior or may be integrated with the housing. For example, the reflective material may line an inside surface of the housing that bounds all or a portion of the housing interior. The reflective material may be a structure that is inherently reflective throughout its bulk, or may be a reflective surface or outer region of a structure, or may be a reflective coating applied to a structure. The reflective material may be a specular reflector such as, for example, a layer or silver (Ag) or aluminum (Al). The reflective material may alternatively be a diffuse reflector such as, for example, a white paint or ink, a non-woven fabric, or a non-woven fabric to which a white paint or ink has been applied. In some implementations, the reflective material is a non-woven mat or substrate formed from a plurality of nanofibers and is highly diffusive. The nanofiber substrate may be the same type of structure as the above-noted substrate utilized to create a PL material. A nanofiber substrate or other type of diffuse reflector may perform as a Lambertian reflector, whereby the brightness of the light scattered from the surface appears to an observer to be the same regardless of the observer's angle of view relative to the surface.

The color of the output light produced by the lighting device depends on the composition of the wavelengths at which the output light is emitted from the light exit of the lighting device. The wavelength composition in turn depends on the wavelengths of light respectively emitted by the light source and the light converter as well as on how the various paths of light components are manipulated or processed (e.g., modulated, reflected, steered, combined, etc.) within the housing interior. The output light may fall primarily within a wavelength band associated with a particular color, or may be a broad-spectrum white light. The lighting device in some implementations produces white light having a CRI of greater than 70, while in other implementations produces white light having a CRI of greater than 80 or greater than 90. These high CRI values may be achieved with the use of either a short-wavelength light source (e.g., UV, violet, or blue) or a white light source (e.g., a white LED) in combination with PL materials emitting secondary light of selected wavelengths. When a white LED is utilized as the light source, the lighting device is able to significantly improve the CRI of the white LED, in some implementations by as much as 35%. In one example, the CRI value of a while LED is rasied from 67 to 90, representing a significant improvement in color rendering properties of the light source. In various implementations, the output light may have a CCT ranging from 2,500 to 5,500 K, and the output light of the lighting device may be tunable over this range through the use of color tuning materials as described below.

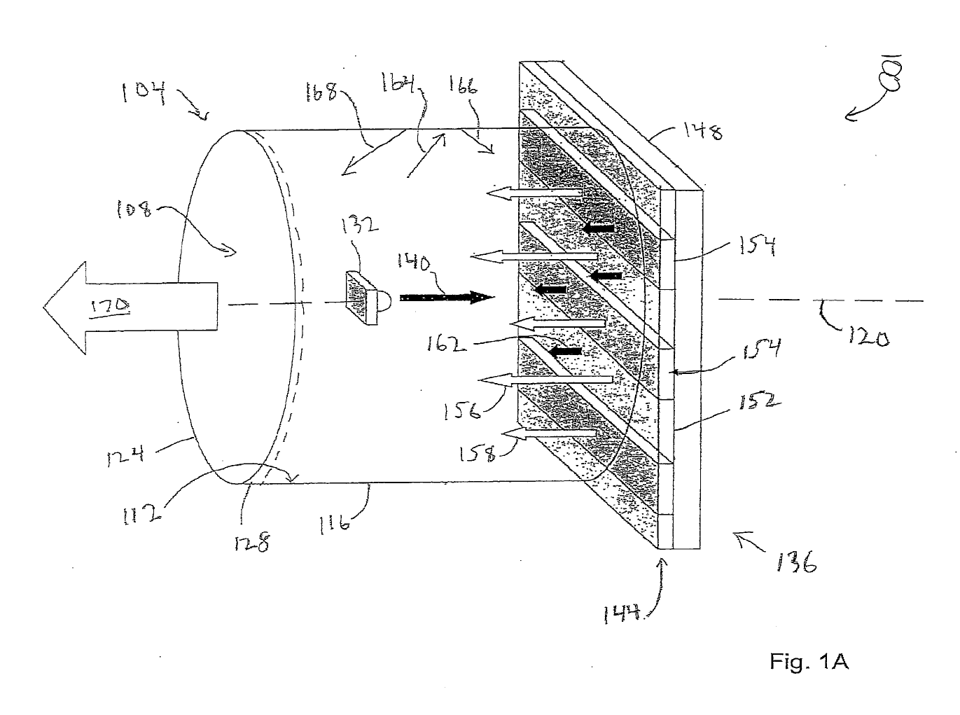

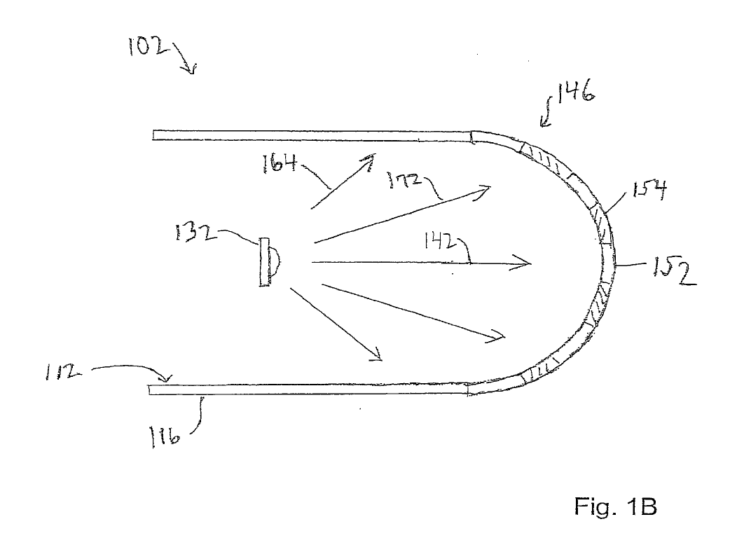

FIG. 1A is a perspective view of an example of a lighting device 100 according to the present teachings. The lighting device 100 includes a housing 104 surrounding a housing interior 108 and a reflective surface 112 disposed in the housing interior 108. In the present example, the housing 104 includes a substrate 116 and the reflective surface 112 is disposed on the substrate 116 whereby the housing interior 108 serves as a reflective cavity. The housing substrate 116 may have any suitable composition. In the present example, the housing substrate 116 is a polymer such as polyvinyl chloride (PVC). Also in the present example, the reflective surface 112 is a diffusive reflective surface and may perform as a Lambertian reflector for the wavelengths at which light components propagate in the housing interior 108. In one specific example, the reflective surface 112 is implemented as one or more layers of highly diffusive nanofibers as described further below. Alternately, the reflective surface 112 may be substantially specular. Generally, the housing 104 (or at least its inside surface) and the reflective surface 112 may have any shape, but advantageously have a shape that promotes distribution and reflection of light components. In the present example, the housing 104 has an axial configuration by which at least the inside surface of the housing 104 is coaxial and symmetrical with a central axis 120. For instance, the housing 104 or its inside surface may be cylindrical. The housing 104 includes a light exit 124 at one axial end. The light exit 124 may be covered with a light-transmitting structure 128 as noted above.

The lighting device 100 further includes a primary light source 132 and a light converter 136. The lighting device 100 further includes a source of electrical power and associated circuitry (not shown) of a design appropriate for powering and controlling the type of light source 132 utilized. In some implementations, the light source 132 is an LED. For example, the light source 132 may be a high-brightness LED such as one from the XLamp® XR-E series commercially available from Cree, Inc., Durham, N.C. The light source 132 is configured to generate and emit a primary light beam at a primary wavelength λₑₘ which in FIG. 1A is schematically represented by an arrow 140. The lighting device circuitry may be configured to enable adjustment of the drive current to the light source 132 and thus adjustment of the intensity of the primary light beam 140. However, as will become evident below the lighting device 100 is able to be color tuned without the need for varying drive current. For purposes of description, the light source 132 and its light beam 140 may be characterized as lying on a nominal output axis of the light source 132. The nominal output axis is generally an axis projecting from the optical output side of the light source 132 directly to the light converter 136 in a straight line, and depicts the general or resultant direction in which the primary light beam 140 is aimed toward the light converter 136. This output axis is “nominal” in the sense that the primary light beam 140 is not necessarily so coherent as to be constrained to the immediate vicinity of the output axis. Instead, in typical implementations the primary light beam 140 has a relatively wide angle of divergence (e.g., is cone-shaped). Depending on the scale of the lighting device 100 and the axial distance between the light source 132 and the light converter 136, a portion of the primary light beam 140 may be directly incident on the reflective surface 112 instead of the light converter 136. Hence, the angular emission of the light source 132 may play a significant role in the performance of the lighting device 100.

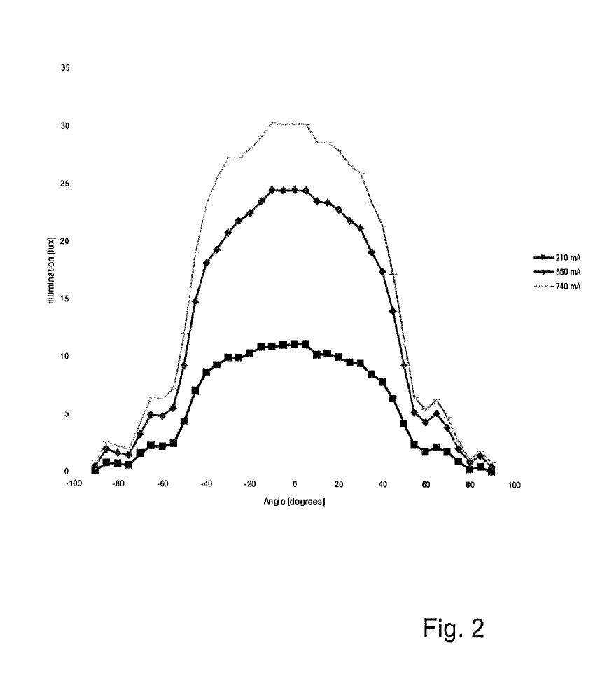

FIG. 2 is a set of angular emission profiles produced by an LED in which illumination intensity (measured in units of lux, or lumens per square meter where 1 lx=1 lm/m²) is plotted as a function of angle (degrees) from the nominal output axis, for three different LED drive currents (210 mA, 560 mA, and 740 mA). The LED in this example is an XREROY model available from Cree, Inc. that emits royal blue light. FIG. 2 shows that an LED may have significant emissions at large angles. Wide-angle emission may result, for example, from surface roughening techniques utilized to increase the light extraction efficiency of the LED.

While in FIG. 1A the nominal output axis is collinear with the central axis 120 of the housing interior 108, this configuration is illustrated by example only. The light source 132 may be mounted such that the nominal output axis is offset from the central axis 120 by a radial distance (orthogonal to the nominal output axis). Moreover, the nominal output axis may not be parallel with the central axis 120 and instead may be at an angle to the central axis 120. The light source 132 may be mounted or suspended in the housing interior 108 and aimed at the light converter 136 by any suitable means. In the present example, the light source 132 is axially interposed between the light exit 124 and the light converter 136. Alternatively, the light source 132 may be axially located at the light exit 124. In implementations where a light-transmitting structure 128 is provided at the light exit 124, the light source 132 may be supported by the light-transmitting structure 128. In other alternatives, the light source 132 may be located outside the housing interior 108 or mounted to the housing substrate 116. More generally, the light source 132 is located so as to direct the primary light beam 140 through the housing interior 108 and toward the light converter 136.

In the illustrated example, the light converter 136 is mounted at the opposite axial end of the housing 104. Alternatively, the light converter 136 may be mounted within the housing interior 108, in which case the opposite axial end may be covered by a reflective surface. The light converter 136 includes a PL material 144 facing the housing interior 108. Depending on its design, the PL material 144 may be supported on or embedded in a suitable substrate to form one or more layers of PL material 144. The light converter 136 may also include an additional substrate or structure 148 on which the PL material 144 is disposed or mounted. The structure 148 may serve as a base or frame for the PL material 144, and may be configured to render the light converter 136 removable from the lighting device 100 such that the light converter 136 can be replaced with another light converter of the same or different configuration of PL materials 144, or modified by the addition of a color tuning material as described below. The substrate of the PL material 144 and/or the structure 148 (if provided) may be reflective. In advantageous implementations, the substrate of the PL material 144 and/or the structure 148 may be diffusively reflective to an appreciable degree so as to promote distribution and mixing of primary light and secondary light in the housing interior 108. Alternatively, particularly in implementations in which the light converter 136 is mounted within the housing interior 108, the substrate of the PL material 144 and/or the structure 148 may be at least partially light-transmitting, in which case some components of primary light and secondary light may be emitted from the back side of the light converter 136 and reflected by a reflector (not shown) located at the axial end. Moreover, the PL material 144 may span the entire cross-section of the axial end of the housing 104 as shown in FIG. 1A, or alternatively may span only a portion of the cross-section, in which case some of the primary light emitted from the light source 132 may bypass the PL material 144 and be reflected from a reflective surface in the housing interior 108.

In the illustrated example, the light converter 136 includes a combination of two different types of PL materials 144, i.e., a first PL material 152 and a second PL material 154, which emit secondary light at two respective wavelengths λ₁ and λ₂ as schematically represented by respective arrows 156, 158 in FIG. 1A. The different PL materials 152, 154 may be arranged in a desired pattern. FIG. 1A illustrates one alternative in which the respective PL materials 152, 154 are arranged in an alternating series of horizontally oriented stripes (the horizontal orientation being merely an example, and merely a consequence of the perspective of FIG. 1A). Some of the primary light incident on the PL materials 152, 154 may not excite a fluorescent or wavelength-shifting response (i.e., not cause re-emission at a different wavelength) and instead is reflected back from the light converter 136. This “unconverted” primary light is schematically represented by other arrows 162 in FIG. 1A.

In operation, activation of the lighting device 100 entails providing power to the light source 132 to energize its light-emitting components. In response, the light source 132 generates the primary light beam 140, which is directed generally toward the light converter 136. A portion of the primary light beam 140 is directly incident on the PL materials 152, 154, i.e., reaches the PL materials 152, 154 without first encountering any other component in the housing interior 108. Another portion of the primary light beam 140 may be directly incident on the reflective surface 112, as schematically represented by an arrow 164 in FIG. 1A. Depending on the diffusivity of the reflective surface 112, some of the primary light striking the reflective surface 112 may then be reflected toward the PL materials 152, 154 as schematically represented by an arrow 166, while another portion of the primary light striking the reflective surface 112 may be reflected toward the light exit 124 as schematically represented by another arrow 168. As regards the primary light striking the PL materials 152, 154, whether directly from the light source 132 (e.g., arrow 140) or as a result of reflection from the reflective surface 112 (e.g., arrow 166), a portion of this incident primary light (140, 166) is converted to secondary light 156, 158 while another portion remains unconverted (162). Components of the unconverted primary light 162 reflected from the PL materials 152, 154, the primary light 166, 168 reflected from the reflective surface 112 without having first struck the PL materials 152, 154, and the secondary light 156, 158 generated by photoluminescence may propagate in different directions through the housing interior 108 and may be reflected one or more times by the reflective surface 112. A mixture of these components passes through the light exit 124 as output light, as schematically represented by a large arrow 170. The output light 170 comprises an ensemble of the primary and secondary wavelengths of electromagnetic radiation (λₑₘ+λ₁+λ₂), and this composition of wavelengths determines the perceived color of the output light 170. The lighting device 100 is structured such that the optical mixing of the different light components (λₑₘ+λ₁+λ₂) is sufficient to produce output light 170 of a desired color having a highly uniform appearance.

As one non-limiting example, the light source 132 may be a short-wavelength emitter such as a blue emitter (e.g., λₑₘ˜450 nm), the first PL material 152 may be an intermediate-wavelength emitter such as a green emitter, and the second PL material 154 may be a longer-wavelength emitter such as a red (or red-orange, or orange) emitter. This configuration results in the output light 170 being white (i.e., broadband visible light). In another example, the light source 132 may be a cool white emitter (typically a phosphor-converted “white” LED) and the PL material 144 may be a red emitter. This configuration results in the output light 170 being warm white. The light converter 136 may also include regions in which the PL materials 144 are absent but which reflect the incident primary light—in effect, the reflective regions add another emitter corresponding to the primary light wavelength (e.g., a blue emitter in the case where a blue light source 132 is utilized).

In other implementations, the light converter 136 may include more than two different types of PL materials 144 or different PL materials 144 as well as a reflective material, in any desired pattern or alternating sequence. For example, three different materials “Y”, “R” and “B” may be provided. In a case where the lighting device 100 is intended to produce white output light 170, Y may represent a luminescent material providing the majority of secondary light utilized to balance the color of the primary light beam 140, R may represent a luminescent material providing secondary light in the long-wavelength part of the visible spectrum, and B may represent a reflective or luminescent material providing secondary light in the short-wavelength part of the visible spectrum. In the case of a blue light source 132, the Y material may be a yellow or green emitter, the R material may be a red, red-orange or orange emitter, and the B material may be a surface that reflects the blue excitation light (e.g., bare nanofibers or other type of reflective surface). For instance, the B material may be a white reflective material. The white reflective material may be a particulate material, examples of which include, but are not limited to, barium sulfate (BaSO₄), titanium (IV) oxide (TiO₂), alumina (Al₂O₃), zinc oxide (ZnO), Teflon® (polytetrafluoroethylene, or PTFE), and combinations of two or more of the foregoing. Alternatively, the B material may be another luminescent material. As examples, in the case of a UV light source 132 (e.g., λₑₘ˜350-370 nm) the B material may be a blue or violet light source 132 (e.g., λₑₘ˜408 nm), and in the case of a violet emitter the B material may be a blue emitter. As another example, the light source 132 may be a UV emitter or a violet emitter (e.g., λₑₘ˜408 nm), the Y material may be a green or yellow emitter, the R material may be a red or orange emitter, and a B material may be a blue emitter. In any case where white output light 170 is desired, the pattern may be configured such that, when located in a desired position relative to the light source 132, the lighting device 100 produces a neutral tone, a cool tone (more blue is reflected or emitted), or a warm tone (more red or other long-wavelength radiation is emitted).

The provision of more than one type of PL material 144 is thus useful in conjunction with a number of configurations of the lighting device 100, particularly when it is desired to produce white output light 170 of a specified color parameter or parameters. However, the provision of only one type of PL material 144 may be useful for certain configurations. For instance, the light source 132 may be a blue emitter and the PL material 144 may be a yellow emitter. In this case, the PL material 144 shifts the blue light to yellow light, which in combination with unconverted blue light results in white output light 170. In another implementation, a blue or cool white emitter may be utilized in conjunction with a single type of long-wavelength emitting (e.g., red) PL material 144. In all such cases, as in the case of utilizing multiple PL materials, adjustments to the color parameter(s) of the resulting white output light 170 may be made by adding an appropriately configured color tuning material to the lighting device 100 in an appropriate manner, as described by way of examples below. The color tuning material may, for example, be configured so as to alter the blueness or redness of the white color of the output light 170.

Testing of prototypes of the lighting device 100 illustrated in FIG. 1A with a two-inch diameter light exit 124 has demonstrated a fixture efficiency of typically 0.74 when either white or blue LED sources were utilized. Fixture efficiency is defined as the luminous output of the device divided by the luminous output of the LED lamp by itself. The efficiency is expected to increase upon further refinement of the design, such as by eliminating light leakages at the junction of the light converter 136 and the housing 104. More generally, the design of the lighting device 100 enables a great amount of flexibility in the selection of the light source 132, the PL materials 144, and other fabrication parameters.

It will be appreciated that the sections of PL materials 144 of the light converter 136 do not all need to have the same cross-sectional areas. Thus, in the example of FIG. 1A, the areas of one or more of the stripes of the first and second PL materials 152, 154 may vary, with some stripes being larger than other stripes, depending on the color parameters sought for the output light 170. Moreover, other patterns of different PL materials 144 may be utilized. For example, the pattern may be an alternating array of circular sectors (i.e., pie-shaped segments) in which each circular sector contains a certain type of PL material 144. The central portion of the primary light beam 140 may illuminate an area of the pattern covering two or more of adjacent sectors such that more than one type of PL material 144 is illuminated. Depending on how the pattern is designed, the primary light beam 140 may be aimed at the center of the array of circular sectors or at a point offset from the center. The circular sectors may all have the same area or some circular sectors may have different areas than others. In other implementations, the light converter 136 may be shaped as a semicircle or an arcuate plate instead of a full circle, with truncated circular sectors or bands of different PL materials 144. In other examples, the pattern may include an alternating series of polygonal shapes (e.g., squares, rectangles, hexagons, triangles, trapezoids, diamonds, etc.) with two or more series of shapes respectively containing two or more different types of PL materials 144. In still other examples, the pattern may include rounded shapes (e.g., ellipses, circles, dots, etc.). Other examples include spirals and irregularly-shaped polygons as well as patterns of dots or circles. Moreover, the pattern may include more than one type of shape. As examples, all first PL materials 152 may have one shape while all second PL materials 154 have a different shape, or some PL materials 152 and/or 154 may have one shape while other PL materials 152 and/or 154 have a different shape.

Moreover, in still other implementations the pattern need not be a uniform arrangement of first PL materials 152 and second PL materials 154. As one example, the first PL material 152 may cover a majority of the area of the light converter 136 while the second PL material 154 (e.g., a longer wavelength emitter) covers only a small section.

Also in some implementations, the PL materials 144 or the entire light converter 136 may be partially or fully encapsulated by any transparent encapsulant suitable for providing a protective barrier. Preferably, the encapsulant is UV-insensitive and not prone to thermal degradation. Examples of encapsulants include, but are not limited to, parylene, silicone (such as those available from Dow Corning of Midland, Mich.), and epoxies (such as those available from Norland Products of Cranbury, N.J.). The encapsulant may be deposited by any suitable technique. One or more of the deposition techniques noted below in conjunction with particle deposition may be suitable.

The PL material 144 described above has been schematically depicted as being planar. It will be understood, however, that the PL materials utilized in the lighting devices encompassed by the present disclosure are not limited to any particular geometry. The PL materials may have a curved profile or a complex geometry. As an example, FIG. 1B is a cross-sectional view of a lighting device 102 similar to that illustrated in FIG. 1A, but with the planar PL material 144 replaced with a curved PL material 146. The curved PL material 146 may be hemispherical, or conform to or approximate another type of conical section (e.g., ellipsoid, paraboloid, hyperboloid, etc.), or may follow another type of curvature. The curvature may be such that the radiant flux of the primary light beam incident on the PL material 146 is approximately constant over most or all of the side of the PL material 146 facing the light source 132. For example, in FIG. 1B the radiant flux of a portion 142 of the primary light beam directed along the nominal output axis may be equal or proximate to the radial flux of some or all portions 172 of the primary light beam directed at angles to the nominal output axis.

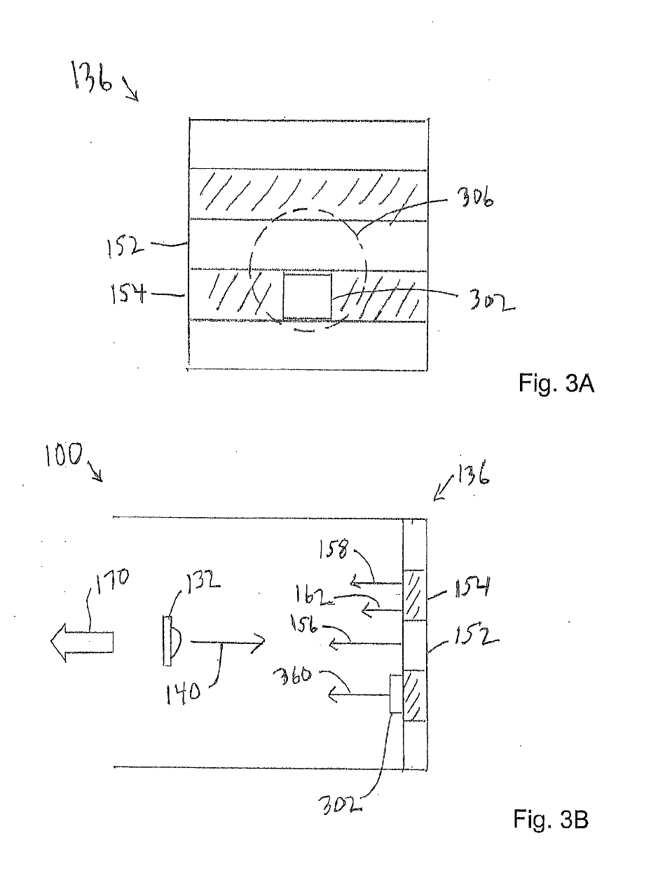

FIG. 3A is a plan view of the light converter 136. In the illustrated example, the light converter 136 includes a pattern of two different PL materials, which for purposes of illustration will be referred to as green emitters 152 and red emitters 154. Also in this example, the pattern is an alternating series of horizontally-oriented stripes of green emitters 152 and red emitters 154 similar to that shown in FIG. 1A. A dashed circle in FIG. 3 depicts a central portion 306 of the primary light beam 140 (FIG. 1A). The size of the area of the central portion 306 depicted in FIG. 3 is arbitrary. The central portion 306 merely corresponds to the brightest area of illumination by the primary light beam 140. This is a result of the planar projection geometry of lighting devices such as shown in FIG. 1A. Moreover, the central portion 306 is centered about the nominal output axis. The radiant flux is typically highest in the vicinity of the nominal output axis along which the light source 132 is directly aimed at the green and red emitters 152, 154, and decreases with radial distance from the nominal output axis due to the fall-off in emission intensity of a typical primary light source 132. Therefore, fluorescent interactions between the primary light beam 140 and the green and red emitters 152, 154 are likely to be more concentrated within the area of the central portion 306.

In the specific example of FIG. 3A, and considering the central portion 306 as a datum representative of the primary light beam 140, the primary light beam 140 is centered on the green and red emitters 152, 154 such that the primary light beam 140 strikes the respective PL materials in equal proportions, i.e., half of this portion 306 of the primary light beam 140 illuminates the green emitters 152 and the other half illuminates the red emitters 154. In theory or approximation, the configuration illustrated in FIG. 3A could be configured to produce equal amounts of green radiation and red radiation. Alternatively, the primary light beam 140 may be oriented such that the central portion 306 illuminates a greater area of the green emitters 152 than the red emitters 154, thereby causing the light converter 136 to emit a greater proportion of secondary light at the green wavelength. This configuration would result in the lighting device 100 producing output light 170 that has an increased proportion of green color, as compared to the case illustrated FIG. 3A. As a further alternative, the primary light beam may be oriented such that the central portion 306 illuminates a greater area of the red emitters 154 than the green emitters 152, thereby causing the light converter 136 to emit a greater proportion of secondary light at the red wavelength. This configuration would result in the lighting device 100 producing output light 170 that has an increased proportion of red color and thus a lower CCT, as compared to the case illustrated FIG. 3A.

For any configuration of the light converter 136 and other components of the lighting device 100, operation of the lighting device 100 produces output light 170 characterized by a composition of unconverted primary light and secondary light propagating at respective wavelengths determined by the primary light source 132 and the luminescent response of the light converter 136. Apart from providing the ability to adjust the drive current fed to the light source 132, the color of the output light 170 may be characterized as being fixed by the manufacturing process, or as “non-adjustable” or “non-tunable” output light 170. However, after the lighting device 100 has been manufactured or provided to the end user, the manufacturer or end user may desire to tune the color of the output light 170. The manufacturer or end user may, for example, measure one or more color parameters of the output light 170 of the as-manufactured lighting device 100 and determine that the measured value differs from a desired value by an unacceptable amount. The desired value may be, for example, a manufacturer's or consumer's specification, a trade association's standard, an industry guideline, or an end user's preference. The desired value may be associated with a range of values within which the difference between the actual (or measured) value and the desired value is deemed acceptable, again according to a specification, standard, guideline, or preference. Alternatively, an end user may wish to adjust the color of the output light 170 without making any measurement or calculation. For instance, the end user may wish to add more redness, blueness or neutrality to the output light 170 based on a visual assessment of the output light 170. In all such cases, according to the present disclosure a color tuning material may be added to the lighting device 100 to adjust the color to the desired value.

FIGS. 3A-12 illustrate various examples of adding a color tuning material to the lighting device 100 to change the color of the output light 170. In quantitative terms, adding the color tuning material may adjust any of several measurable or calculable color parameters of the output light 170 such as, for example, SPD, CRI, CCT, CIE chromaticity coordinates, and distance from Plankian locus. The resultant change in the color of the output light 170 is not limited to large chromatic shifts, such as from green to yellow or yellow to orange. In more typical implementations, the change in color is more in the nature of fine tuning, such as adjusting the amount of blue or red in the output light 170. As an example contemplated for many lighting applications, the lighting device 100 may be configured to produce white output light 170. In this case, the color tuning material may be utilized to adjust the relative amount(s) of blue, green and/or red (or any other peak emission of a desired wavelength) in the white output light 170, thereby changing the whiteness (e.g., coolness, neutrality or warmth) of the output light 170.

The color tuning material may include the same types of PL materials utilized for the light converter 136. Thus, the color tuning material may include luminescent particles configured to emit light at one or more desired wavelengths in response to excitation by the primary light beam 140. Alternatively or additionally, the color tuning material may include a reflective material that “emits” light at the primary wavelength, i.e. reflects the primary light incident thereon such as blue light in the case of a blue-emitting light source 132. In typical implementations, the reflective color tuning material is a white material that preferably is highly reflective of light of the primary wavelength. The white reflective material may be a particulate material, examples of which are noted elsewhere in the present disclosure.

The color tuning material may be a single type of particle (e.g., particles having a composition, size, etc. that results in emission at a single dominant wavelength), or may include more than one type of particle. Two or more different types of particles may be arranged in a desired pattern in a manner analogous to configuring the PL materials of the light converter 136 described above. More typically, the color tuning material is a single type of particle that is added in a strategic location of the lighting device 100 as a result of determining that the output light 170 should contain a greater proportion of photons centered on a specific wavelength. For instance, if it is determined that the color of the output light 170 should have an increased proportion of red, a red-emitting color tuning material would be added at an appropriate location of the lighting device 100 to effect a greater contribution of a red wavelength in the output light 170. After adding the red-emitting color tuning material, the output light 170 may be re-evaluated. If upon re-evaluation it is determined that the proportion of red in the color of the output light 170 should be increased further, another iteration of color tuning may be performed. As examples, another layer of color tuning material may be added to the same location as the previously added color tuning material to increase the density of the particles at that location, or an additional color tuning material may be added to another location for similar additive effects. The location of the color tuning material may be determined based on its position relative to the light source 132. For example, the color tuning material may be added at a location that receives a relatively intense portion of the primary light beam 140 to make a relatively pronounced color adjustment, or at a location that receives a less intense portion of the primary light beam 140 to make a finer color adjustment. Moreover, an additional color tuning material may include a different type of light emitter than a previously added color tuning material to effect finer tuning. For example, an orange or green emitter may be added after first adding a red emitter.

The color tuning material may be added to any target surface of the lighting device 100 that is optically aligned with the primary light source 132, i.e., that receives at least a portion of the primary light emitted from the primary light source 132. For this purpose, in some implementations the color tuning material is added to the target surface as a solution or ink that includes luminescent and/or reflective particles and one or more appropriate solvents. In the present context, for convenience the term “deposited” represents any technique for adding particles, whether by material transport (e.g., printing, coating via an applicator or dispenser instrument, etc.), immersion, self-assembly, etc. Depending on the types of particles to be deposited, the solvents may be organic or inorganic and may be polar or non-polar. The solution may also include any additives deemed appropriate or necessary, such as particle dispersants, surfactants, viscosifiers, agents that inhibit agglomeration or slumping, agents that control solution rheology, agents that promote adhesion to the target surface receiving the solution, agents that control wetting properties, agents that control the resolution of the pattern of the particles applied to the target surface, agents that facilitate the use of a particular dispensing device utilized to apply the solution to the target surface (a “color tuning material dispenser”), and/or agents that control any other property of the solution deemed important. As a few specific but non-limiting examples, the additive BYK®-411 commercially available from BYK-Chemie GmbH, Germany may be added as a surfactant, and the alkyd Beckosol® 11-035 commercially available from Riechhold Inc., Durham, N.C. may be added as a dispersant. After deposition, the solution may be cured to form a stable, permanent layer of particles. Curing may be carried out in any manner suitable for the composition of the particles being deposited, such as, for example, air drying, heating, UV-curing, etc. Curing may entail the evaporation of excess volatile components, which may be assisted by vacuum.

In some implementations, the color tuning material may be applied as a solution directly to any target surface that is compatible with forming the layer of color tuning material—that is, a surface that permits the solution to be applied and then cured into a stable, permanent layer of color tuning material. In other implementations, the color tuning material additionally includes a substrate. The substrate may be any structure compatible with forming the layer of color tuning material on the substrate. Thus, the substrate may be the same type of substrate utilized for forming PL materials 144 of the light converter 136, which are described elsewhere in the present disclosure. In this case, the color tuning material (i.e., the substrate and layer of luminescent or reflective particles) is applied to a target surface by positioning the substrate on the target surface in any stable, fixed manner such as by adhesion, bonding, or fastening.

Any dispensing technique suitable for the type of color tuning material and non-destructive of the underlying component may be utilized. Preferably, the dispensing technique is one that deposits particles uniformly on the underlying component. One or more of the additives noted above may also ensure uniform deposition. Examples of dispensing techniques include, but are not limited to, printing techniques, wet coating techniques, and dry coating techniques. Examples of printing techniques include, but are not limited to, ink jet printing, digital printing, screen printing, thermal printing, transfer printing, etc. Examples of wet coating techniques include, but are not limited to, spray coating, dip coating, drop coating, spin coating, electrospray coating, doctor blading, deposition of Langmuir-Blodgett film, self-assembly of monolayers (SAMs) from liquid or vapor phase, etc. Examples of dry coating techniques include, but are not limited to, aerosol dry coating. Non-immersion techniques may utilize a suitable solution or ink dispensing apparatus (i.e., a dispenser or applicator) that may be manipulated manually or in an automated manner. Examples of dispensers include, but are not limited to, a syringe, a capillary, a printing pen, a printing pad or stamp, an ink jet printing head, a spray nozzle, an electrospray needle, devices utilized in microfluidics, micro-total analysis, labs-on-a-chip, etc.

The particular dispensing technique performed may depend on a number of factors. For instance, some dispensing techniques may be suitable for in situ addition of the color tuning material, i.e., applying the solution to a target surface or component of the lighting device 100 without removing the target surface or component from the lighting device 100. For example, a syringe, printing pen, a printing pad or stamp, spray head or the like may be inserted into the housing interior 108 to apply the color tuning material directly to a surface or component located therein. Other dispensing techniques may be more suitable for ex situ addition of the color tuning material, i.e., applying the solution to the target surface after the component that includes the surface has been removed from the lighting device 100, and possibly mounted to an apparatus associated with the color tuning material dispenser. For example, the light converter 136 may be removed to facilitate access by any suitable color tuning material dispenser, or mounted to an ink-jet printing apparatus or a spin-coating apparatus, etc. Moreover, some dispensing techniques may be particularly suitable when the luminescent or reflective particles are applied to a substrate of the color tuning material.

In some implementations, a coating that is or includes a surface treatment (or surface modifier) chemistry (a “surface treatment coating”) may be applied to the target surface before depositing one or more layers of color tuning materials. The surface treatment coating may have a composition selected to control and improve adhesion, control wetting properties, and/or control pattern resolution (i.e., the pattern in which the particles are deposited on the underlying surface, as opposed to a pattern of sections of different types of particles). Examples of suitable surface treatment coatings include, but are not limited to, polyacrylates, parylenes, and polymers that can be deposited via chemical vapor deposition (CVD). In the case of a photoluminescent nanofiber (PLN) substrate, coatings that are optically transparent and do not expose the nanofibers to aggressive solvents that degrade the polymer fibers are acceptable. In more specific examples, poly(methyl methacrylate) (PMMA) and poly(lauryl methacrylate) (PLMA) have been found to be particularly suitable. The surface treatment coating may be deposited by any suitable technique. One or more of the deposition techniques noted above in conjunction with particle deposition may be suitable. The surface treatment coating may be deposited as a solution containing the component possessing the surface treating or modifying function (e.g., polyacrylates) and one or more suitable solvents such as, for example, toluene, hexane, etc. Non-fluorescent filler particles such as TiO₂, SiO₂, Al₂O₃ CaCO₃, bentonite and other clays may be utilized to increase the light reflectance and overall intensity of the PLN and control the degree of hide of the phosphor coating.

In some implementations, an ink-jet printer is utilized to deposit a solution of color tuning material on a target substrate or other component. One example of a suitable ink-jet printer is the Dimatix Materials Printer DMP-2800 commercially available from FUJIFILM Dimatix, Inc., Santa Clara, Calif. The ink jet printer may include a frame at which the target substrate is mounted, a piezoelectric-driven ink jet printhead, and an assembly of mechanical and motorized components configured to move the printhead in a controlled manner along one, two or three axes. The target substrate may be mounted on a platen (not shown) of the frame that is rotatable in a controlled manner. Either the frame or the printhead may allow adjustment of the vertical distance between the printhead and the target substrate. The printhead may include a reservoir for the particle solution and a bank of nozzles. The printhead is configured to form a layer or section of color tuning material of an accurately controlled size and shape. If desired, two or more sections of color tuning materials may be formed in any desired pattern. The particle solution may have a desired concentration of particles in the solvent (e.g., in the mg/ml range, such as 40 or 80 mg/ml). Various deposition (printing) parameters may be controlled such as number of jets firing, drop firing velocity (e.g., in the m/s range, such as 7 or 9 m/s, drop firing waveform (e.g., in the Hz range, such as 5 Hz), drop space (e.g., in the micron range, such as 25 μm), and drop size (e.g., in the picoliter range), etc.

In addition, the resolution at which the particle solution is printed and the deposition (printing) pattern may be controlled. Generally, particle solutions may be deposited in precisely metered aliquots or volumes, which may be characterized as deposition units. Each deposition unit may have a characteristic dimension (e.g., diameter, length, width, etc.) on the order of millimeters, microns, or fractions of an inch, and thus may contain a large quantity of particles. Moreover, the periodicity of or spacing between neighboring deposition units may also be controlled by controlling one or more the above-noted deposition parameters, and may also be on the order of millimeters, microns, or fractions of an inch. The deposition units may have any shape such as, for example, stripes, lines, circles, dots, ellipses, diamonds, other polygons, etc. As an example, the diameter or other characteristic dimension of the deposition unit may be 0.05 or 0.10 inch and the spacing between adjacent deposition units along a row or column may also be about 0.05 or 0.10 inch. Applying a color tuning material with a controlled resolution in this manner may be utilized to accurately adjust the end properties of the output light produced by a lighting device to which the color material is added. A computer software program executed by hardware provided with or communicating with the ink-jet printer may be utilized to control resolution and various other deposition parameters.

As illustrated in FIG. 3A, a color tuning material 302 may be added directly to the PL material of the light converter 136. Specifically in this example, the color tuning material 302 has been added as a layer covering a portion of a section of red emitters 154. More specifically, the color tuning material 302 has been added to a section of red emitters 154 that is irradiated by the central portion 306 of the primary light beam 140 (FIG. 1A). This addition results in increasing the density of red emitting particles in the area corresponding to the added color tuning material 302. Moreover, because the addition was made to an area irradiated by the central portion 306, this instance of color tuning may result in an appreciable increase in the amount of red in the output light 170 (FIG. 1A). Alternatively, the red-emitting color tuning material 302 may be added so as to cover a portion of a section of green emitters 152, with the similar result that the proportion of red in the output light 170 will be increased. In this case, the process of adding the red-emitting color tuning material 302 may also be characterized as a subtractive process in the sense that the proportion of green-emitting light components in the output light 170 may effectively be lowered. The decision to add red-emitting color tuning material 302 may be based, for instance, on a desire to lower the CCT or increase the CRI of the output light 170. Alternatively, if it is desired to increase the CCT of the output light 170, a green-emitting color tuning material 302 may be added to a section of green emitters 152 or to a section of red emitters 154. It will also be understood that the color tuning material 302 may be sized and shaped to cover an entire section of PL material (such as an entire stripe in the present example) instead of only a portion of that section.

FIG. 3B illustrates an example of the effect of adding the color tuning material 302 to the lighting device 100. Specifically, FIG. 3B is a side view of the lighting device 100 illustrated in FIG. 1, with the color tuning material 302 added as illustrated in FIG. 3A. Before adding the color tuning material 302, the output light 170 resulted from a contribution of unconverted primary light 162 such as that reflected from the light converter 136, and secondary light emitted from the light converter which in the present example includes a first wavelength 156 (e.g., green) and a second wavelength 158 (e.g., red). The addition of the color tuning material 302, whether reflective particles or luminescent particles, has the effect of adding auxiliary or supplemental light components 360 to the output light 170. Therefore, after adding the color tuning material 302, the output light 170 results from a contribution of unconverted primary light 162, secondary light 156, 158 emitted from the light converter 136, and auxiliary light 360 emitted from the color tuning material 302.

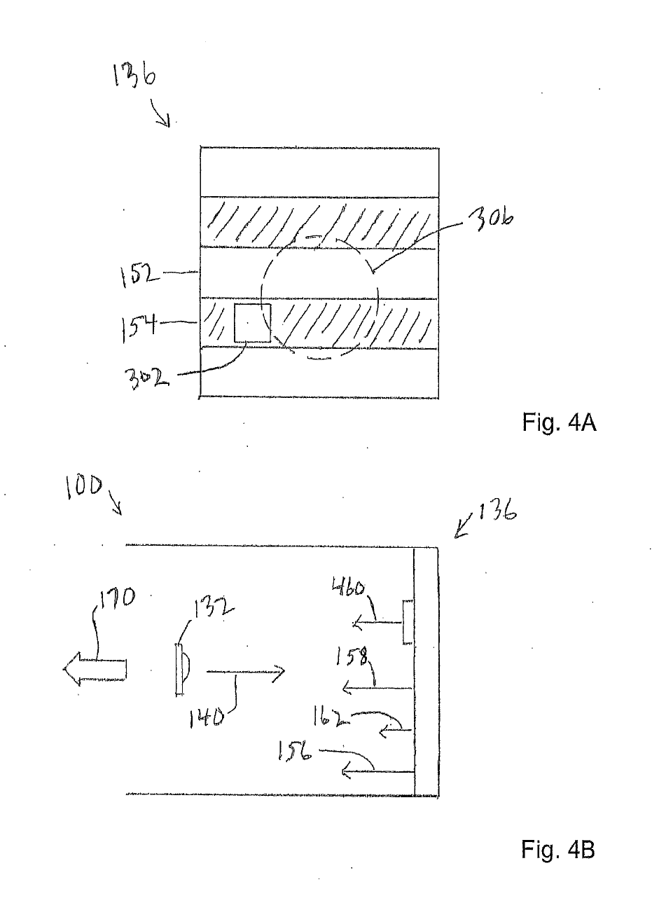

FIG. 4A illustrates another example of adding the color tuning material 302 directly to the PL material of the light converter 136. In this example, the color tuning material 302 has been added as a layer covering a portion of the same section of red emitters 154 as in the case of FIG. 3A, but at a location that is outside of or only partially irradiated by the central portion 306 of the primary light beam 140. This addition again results in increasing the density of red emitting particles in the area corresponding to the added color tuning material 302, but the increase in red emissions may be less than that corresponding to FIG. 3A because the added color tuning material 302 is irradiated by a less intense portion of the primary light. FIG. 4B illustrates the effect of adding the color tuning material 302 to the lighting device 100 in the manner illustrated in FIG. 4A. Again, the addition of the color tuning material 302 adds auxiliary light 460 to the output light 170, but to a lesser degree as compared with the configuration illustrated in FIG. 3B. It will be understood that the various arrows illustrated in FIGS. 3B and 4B have been arbitrarily located.

For implementations in which the light converter 136 has a curved geometry and the radiant flux striking the PL materials is approximately constant over the entire or a substantial portion of the area of the PL materials (e.g., FIG. 1B), the selection of different positions of the color tuning material 302 such as illustrated in FIGS. 3A and 3B and FIGS. 4A and 4B will typically have less of an impact on color tuning.

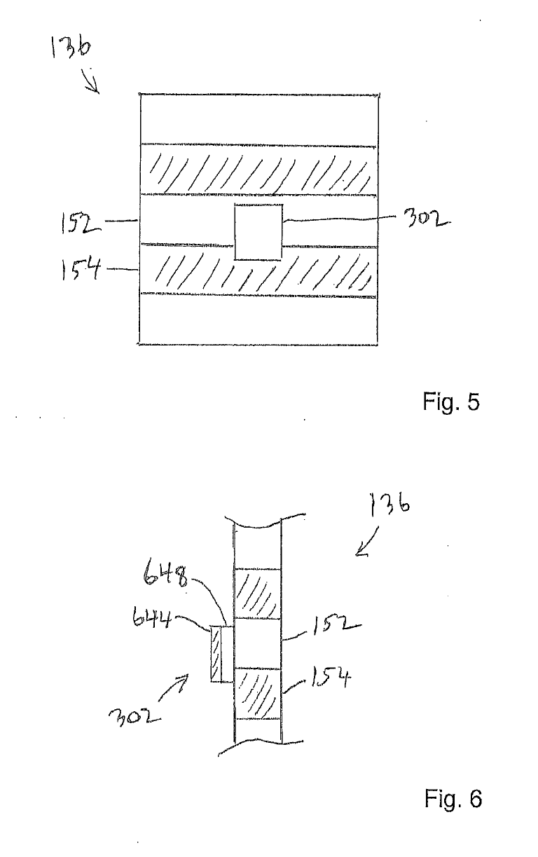

FIG. 5 illustrates another example of adding the color tuning material 302 directly to the PL material of the light converter 136. In this example, the color tuning material 302 is sized so as to cover or at least overlap with two sections of different PL materials (e.g., green and red emitters 152, 154) of the light converter 136. It will also be appreciated that the color tuning material 302 may have any desired shape, i.e., the rectilinear shape is illustrated merely as one example.

FIG. 6 illustrates another example of adding the color tuning material to the PL material of the light converter 136. In this example, the color tuning material 302 includes not only a layer of particles 644 but also a substrate 648 supporting the particles 644. The substrate 648 may be structured as described elsewhere in the present disclosure. In one implementation, the substrate 648 is a nanofiber substrate. Relative to the typically larger-area light converter 136, the nanofiber substrate may be characterized as a nanofiber patch or swatch.

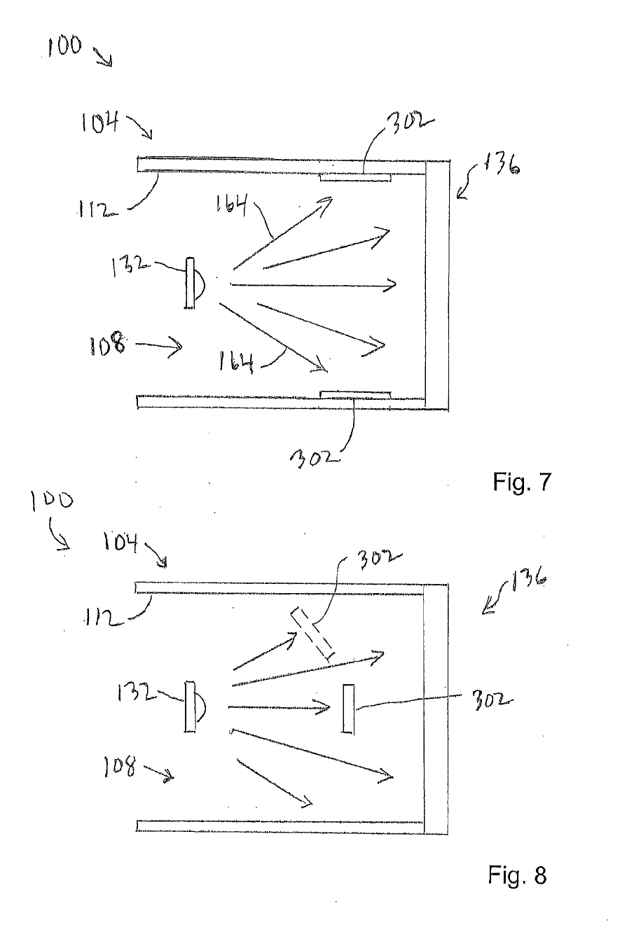

FIG. 7 illustrates an example of adding the color tuning material 302 to another surface disposed in the housing interior 108. As in other implementations, the color tuning material 302 may be a layer of particles or a substrate/particle composite. In this example, the target surface to which the color tuning material 302 is applied is the inside surface of the housing 104 or a reflective surface 112 lining the inside surface of the housing 104. In this case, the area of the inside surface (or reflective surface 112) covered by the color tuning material 302 emits auxiliary light instead of reflecting or absorbing the portion 164 of the primary light beam incident thereon. Due to the lower intensity of the primary light radiation in this area, the effect of color tuning in this case may be less pronounced as compared to the configurations illustrated in FIGS. 3A-6. FIG. 7 also illustrates an implementation in which two or more color tuning materials (or material units) are added at separate locations of the lighting device 100. As examples, multiple color tuning materials may be added to different locations of the inside surface (or reflective surface 112) as illustrated, or different locations of the light converter 136, or different locations of both the inside surface (or reflective surface 112) and the light converter 136.

FIG. 8 illustrates additional examples of adding the color tuning material 302 (layer of particles or substrate/particle composite) to the lighting device 100. As in other implementations, the color tuning material 302 is positioned in the housing interior 108 so as to be optically interposed between the light source 132 and the light converter 136 or the inside surface (or reflective surface 112) of the housing 104, such that at least a portion of the primary light strikes the color tuning material 302 instead of a corresponding area of the light converter 136 or the inside surface (or reflective surface 112). In FIG. 8, however, the color tuning material 302 is suspended or supported by any suitable means in the housing interior 108 instead of being directly mounted to the light converter 136 or the inside surface (or reflective surface 112).

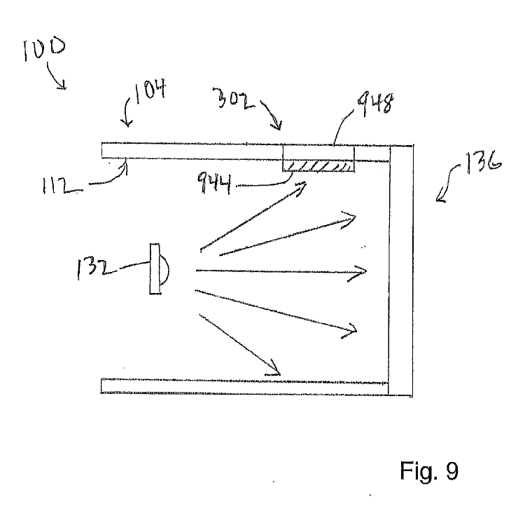

FIG. 9 illustrates another example of adding the color tuning material 302 to the lighting device 100. In this implementation, the lighting device 100 is provided with a “blank” color tuning material substrate 948, i.e., a substrate to which particles have not yet been added. The substrate 948 may be positioned at any location of the lighting device 100 found to be suitable for adding color tuning material 302. In the present example, the substrate 948 is positioned on or embedded in the inside surface (or reflective surface 112) of the housing 104. The substrate 948 may be configured so as to be reflective of primary and secondary light components. To tune the color of the output light of the lighting device 100, a layer of reflective or luminescent particles 944 is added to the substrate 948 pursuant to any appropriate technique described herein.

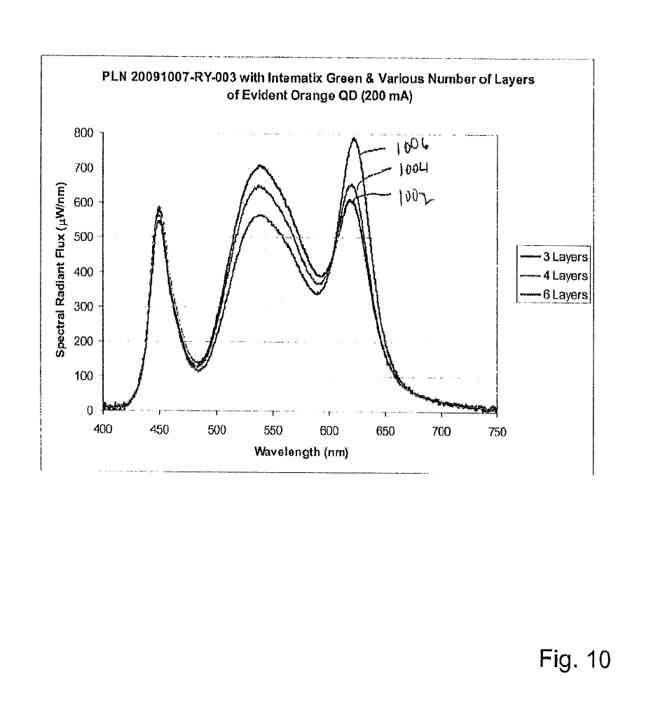

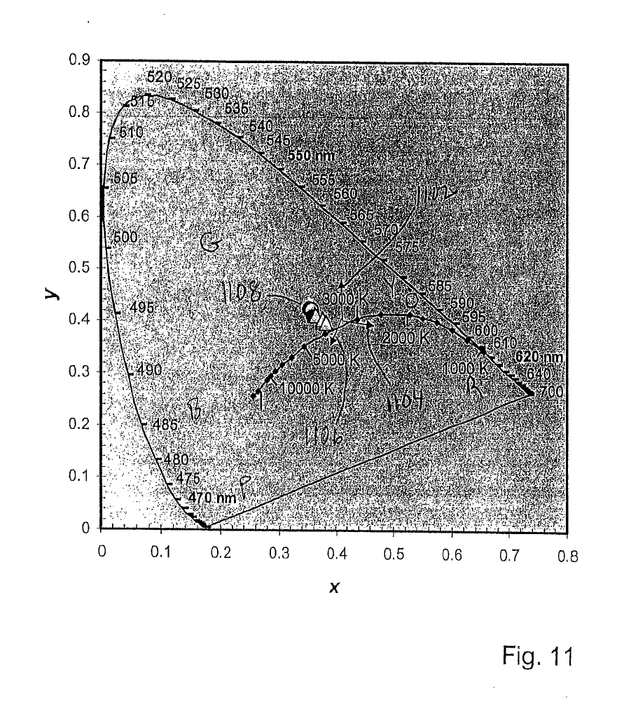

FIG. 10 is a set of spectral power distribution (SPD) curves, specifically spectral radiant flux (μW/nm) as a function of wavelength (nm), acquired by operating a prototype lighting device after three iterations of adding color tuning materials. The SPD curves were generated utilizing a calibrated integrating sphere equipped with a fiber optic spectrometer. Measurements were taken using procedures described in IESNA (Illuminating Engineering Society of North America) standard test method LM-79-08 “Electrical and Photometric Measurements of Solid-State Lighting Products.” The lighting device was configured as illustrated in FIG. 1A, with a two-inch diameter housing cavity, a blue-emitting light source (excitation wavelength ˜450 nm), and a light converter presenting a pattern of horizontal stripes of alternating green-emitting and orange-emitting materials. The light converter was fabricated by fabricating a nonwoven nanofiber substrate, coating the substrate with a green-emitting phosphor obtained from Internatix Corp., Fremont, Calif., and overlaying the green-emitting phosphor coating with stripe-shaped areas of orange-emitting QDs (dominant wavelength ˜615 nm) obtained from Evident Technologies, Inc., Troy, N.Y. The QDs were dispensed using a piezoelectric-driven inkjet printer. In this example, the color tuning materials utilized were the same orange-emitting QDs utilized when fabricating the light converter. In the first iteration, three layers of the orange-emitting QDs were added to an existing orange-emitting stripe of the light converter. In the second iteration, an additional layer of the orange-emitting QDs was added to the previously added three layers. In the third iteration, an additional two layers of the orange-emitting QDs were added to the previously added four layers.

FIG. 10 thus illustrates the SPD curves of the output light after adding three layers 1002, four layers 1004, and six layers 1006, respectively. As demonstrated, the successive additions of orange-emitting QDs increased emissions at around 615 nm while decreasing emissions at around 540 nm. To calculate the effect of each iteration of adding orange-emitting QDs on CCT and CRI, the SPD data was inputted into a software program. The results showed that CCT was successively lowered and CRI was successively increased, as follows:

Three layers: CCT=4,800K; CRI=77

Four layers: CCT=4,600K; CRI=81

Six layers: CCT=4,100K; CRI=90

It can be appreciated that adding green-emitting color tuning materials would successively increase emissions at around 540 nm. Moreover, adding reflective color tuning materials would successively increase emissions at around 450 nm.

It can also be seen that smaller additions of color tuning materials will produce smaller changes in CCT and CRI. Moreover the addition of, for instance, green-emitting, red-emitting or blue-emitting (or reflective) color tuning materials may be done in a manner that changes the chromaticity coordinates in a linear manner. Thus, color parameters such as CCT and CRI values can be accurately titrated by the addition of luminescent and/or reflective color tuning materials that provide auxiliary light components at wavelengths appropriate for the configuration of the light converter and other optical-processing components of the lighting device.

FIG. 11 is a representation of a CIE 1931 (x, y) chromaticity diagram in which the effects of adding one or more color tuning materials to a lighting device are illustrated. As appreciated by persons skilled in the art, the color space is bounded by the curved spectral locus shown in FIG. 11, which is indexed by wavelengths given in nanometers, and by the straight line that interconnects the two ends of the spectral locus. Red, green, blue, yellow, orange and purple regions of the color space are generally designated R, G, B, Y, O and P, respectively. The curved line in the color space is the Plankian locus, which is indexed by CCT values. For simplicity, isotherms (or lines of constant CCT) crossing the Plankian locus are not shown.

An arrow 1102 in FIG. 11 illustrates the impact of adding a green-emitting color tuning material to the lighting device. Increasing green emission typically results in increasing the y chromaticity coordinate. In typical implementations of the presently disclosed techniques, green material is added if the chromaticity coordinates lie below the Plankian locus. Another arrow 1104 illustrates the impact of adding a red-emitting color tuning material to the lighting device. Increasing red emission decreases CCT and increases the x chromaticity coordinate. Typically, red material is added if the chromaticity coordinates lie above the Plankian locus. Another arrow 1106 illustrates the impact of adding a reflective color tuning material such as a white material to the lighting device in a case where the light source is a blue emitter. Equivalently, the arrow 1106 illustrates the impact of adding a blue-emitting color tuning material responsive to a short-wavelength (UV or violet) light source. Either case increases blue emission, which increases CCT and decreases the x chromaticity coordinate. It will be appreciated that adding more than one type of color tuning material can be done to produce various other color tuning effects intermediate to the three examples just described.

FIG. 11 also illustrates an example of iteratively adding an orange-emitting material to the lighting device, such as an ink containing orange QDs as in the example above relating to FIG. 10. Before adding the orange ink, the chromaticity coordinates of the output light are initially positioned at 1108. Successive additions of layers of orange ink are indicated by triangles. It can be seen that each addition of the orange ink titrates the properties of the output light toward the Plankian locus, which allows greater control over CCT, CRI, and (x,y) values. In this example, the movement of the chromaticity toward the Plankian locus results from increasing the x chromaticity coordinate and decreasing they chromaticity coordinate.

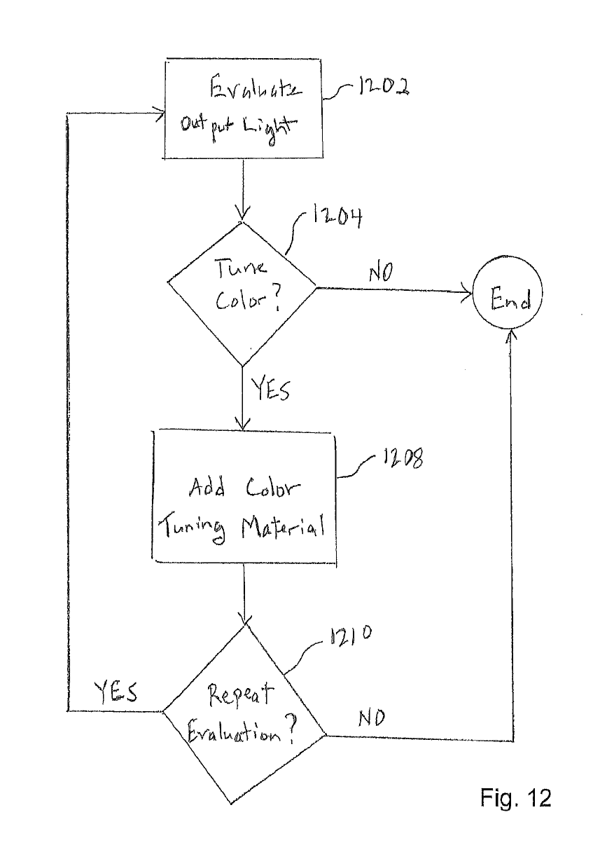

FIG. 12 is a flow diagram illustrating an example of a method or process for tuning the color of output light produced by a lighting device. As a preliminary step, the lighting device is operated to produce output light. The output light is then evaluated or assessed (block 1202). This evaluation may be performed, for example, at the EOL by a manufacturer as part of screening procedure or by an end user after the lighting device has been installed or otherwise put in use. As noted above, the evaluation may entail a visual assessment of the color of the output light, or may be a more rigorous procedure in which data relating to actual values of one or more types of color parameters are acquired. As an example, SPD data may be acquired and utilized to calculate CRI, CCT, chromaticity coordinates, and/or distance from Plankian locus. Spectral measurements may be acquired by utilizing, for example, a spectroradiometer or a tristimulus colorimeter. The calculations may be done according to predefined standards or guidelines such as those promulgated by CIE or other entities, or according to a manufacturer's specifications, a customer's requirements, or a user's preference. Some or all calculations may be done by executing one or more computer software programs.

After evaluating the output light, a determination is made as to whether the color of the output light should be tuned (decision block 1204), which in quantitative terms may entail a determination as to whether one or more color parameters should be adjusted. If it is determined that the color should not be tuned, then the method may end (end point 1206). If, on the other hand, it is determined that the color should be tuned, then color tuning material is added (block 1208) pursuant to any of the techniques described herein. As an example, adding the color tuning material may entail operating a dispensing apparatus to apply a particle-inclusive solution or ink to one or more selected surfaces or components of the lighting device. As another example, adding the color tuning material may entail operating a dispensing apparatus to prepare one or more substrate-based color tuning materials, and subsequently mounting the color tuning material or materials to one or more surfaces or components or at other locations in the housing interior. As another example, adding the color tuning material may entail selecting a prefabricated substrate-based color tuning material from a plurality of differently configured color tuning materials made available to the user. In all such cases, the configuration of the color tuning material—e.g., the composition of the color tuning material and/or its position in the lighting device—may be based on a determination of the type of color parameter to be adjusted and the magnitude of the adjustment. The magnitude of the adjustment may be based on a desired or target value of one or more types of color parameters. The desired value may fall within a range of values deemed acceptable for the color sought for the output light. For example, the range may be a range of error or tolerance about a single desired value of a given color parameter (e.g., ±1%).

After the color tuning material has been added to the lighting device, a decision is made as to whether to repeat the evaluation (decision block 1210). If it is determined that the evaluation should not be repeated, then the method may end (end point 1206). If, on the other hand, it is determined that the evaluation should repeated, then the method returns to block 1202 and the process represented by blocks 1202-1210 is repeated in one or more iterations until it is determined that no further color adjustments are needed. The re-evaluation may be done to determine whether the first iteration of adding the color tuning material (block 1208) tuned the color of the output light by a sufficient amount. As an example, the first iteration of adding the color tuning material may be characterized as moving the value of a given color parameter from an initial (non-adjusted) value to a new (adjusted) value. The first iteration may have moved the value to the desired value, or may have moved the value closer but not equal to the desired value. If the new value does not equal the desired value, or alternately does not fall within an acceptable range of the desired value, then it may be decided to make an additional adjustment (block 1204). As already noted, this process may be repeated one or more times.

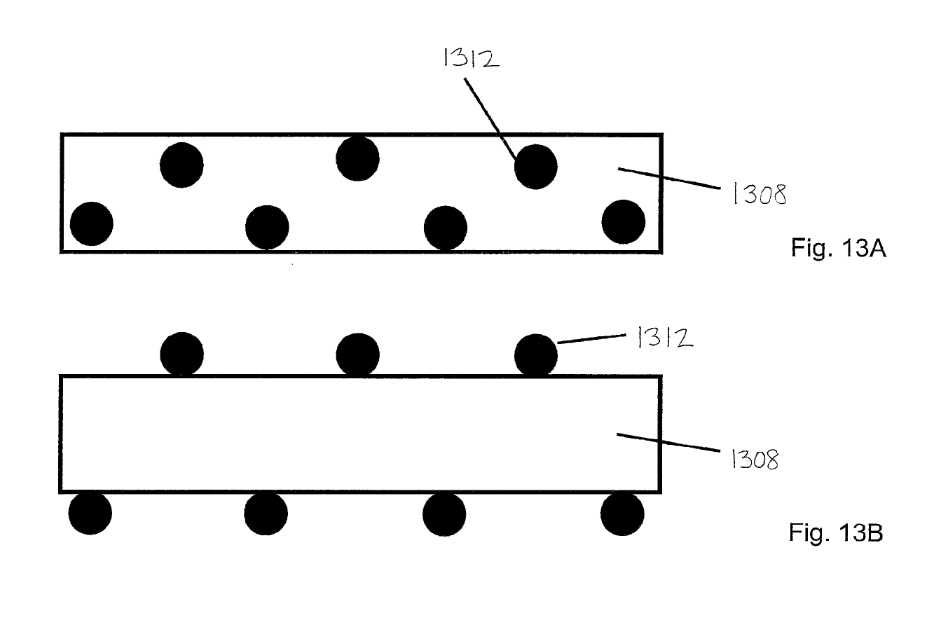

According to some implementations, the reflective materials, PL materials and/or color tuning materials utilized in any of the lighting devices taught herein may be based on nanofiber substrates formed from a plurality of nanofibers. FIGS. 13A and 13B are schematic views of a nanofiber 1308 or portion thereof. A plurality of such nanofibers 1308 may be collected and formed into a nanofiber substrate. In some implementations, luminescent (or luminescent and reflective) particles may thereafter be applied to the nanofiber substrate in layers and/or sections as described above. Some particles 1312 may be supported directly on outer surfaces of the nanofibers 1308 as shown in FIG. 13B. In such implementations, these nanofibers 1308 may be located at the substrate surface or also in an upper region of the nanofiber substrate. In some implementations, the average diameter of the luminescent particles 1312 is smaller than the average diameter of the nanofiber 1308.

In alternative implementations, certain particles 1312 may be added to the nanofiber precursor and thus included with the as-formed nanofibers 1308 to form a base PLN composite. In these implementations, FIG. 13A illustrates a case in which particles 1312 are disposed in the bulk of the nanofiber 1308, and FIG. 13B illustrates a case in which particles 1312 are disposed on the nanofiber 1308. In the present context, an arrangement of particles 1312 “disposed on” the nanofiber 1308 encompasses particles 1312 disposed on an outer surface of the nanofiber 1308, and/or particles 1312 disposed at least partially in an outer region of the nanofiber 1308 and protruding from the outer surface. When the particles 1312 are luminescent and supported directly by nanofibers 1308 as illustrated in FIG. 13A or 13B, the resulting fibers may be referred to as luminescent fibers or light-stimulable fibers.

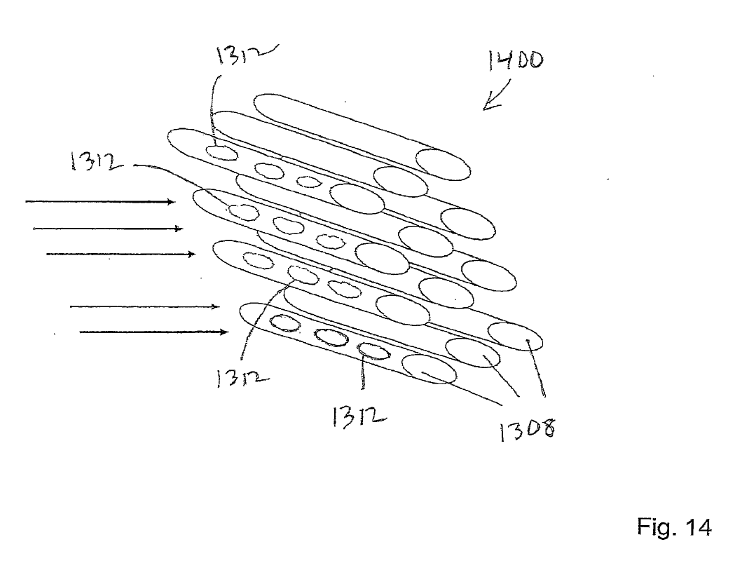

FIG. 14 is a schematic view of an example of a nanofiber substrate 1400 (or portion of a nanofiber substrate 1400) formed from a plurality of nanofibers 1308. The nanofiber substrate 1400 may be structured as a nonwoven mat. In some implementations, the nanofiber substrate 1400 may be considered as including one or more layers of nanofibers 1308. When utilized as a PL material (a “PLN composite” or “PLN substrate”), the nanofiber substrate 1400 may support one or more layers of particles and/or may include luminescent fibers structured as shown in either FIG. 13A or FIG. 13B or a combination of both types of luminescent fibers shown in FIG. 13A and FIG. 13B.

As a bulk property, the nanofiber substrate 1400 may be considered to function as an optical scattering center for incident light. Light scattering from the nanofibers 1308 is believed to depend on the wavelength λ, of the light, the diameter of the nanofibers 1308, the orientation of the nanofibers 1308 relative to the incident light, the surface morphology of the nanofibers 1308, and the refractive index of the nanofibers 1308. In some implementations, polymer nanofibers 1308 have refractive indices ranging from 1.3 to 1.6. Incident light may be scattered by the nanofibers 1308 and interact with particles 1312 supported by the nanofiber substrate 1400 or incorporated with the nanofibers 1308. Each nanofiber 1308 may provide an individual scattering site for light incident thereon. Moreover, the nanofiber substrate 1400 may serve as a medium for effectively (and temporarily) capturing, trapping or confining photons of the incident light. These attributes increase the probability of interaction between the particles 1312 and incident light. Hence, when utilized as a light converter or a color tuning material, the PLN substrates taught herein more efficiently capture excitation photons and re-radiate photons at visible wavelengths with higher intensities than would be possible with conventional, non-fibrous light converters. The superior performance of the nanofiber substrate 1400 over a comparative polymer solid film—both samples containing a uniform dispersion of the same type of luminescent QDs and an equal number of QDs—has been verified by testing as disclosed in U.S. Patent Application Pub. No. 2008/0113214.

In some examples, the nanofibers 1308 of the nanofiber substrate 1400 may have an average fiber diameter ranging from 10 to 5,000 nm; in other examples ranging from 100 to 2,000 nm; in other examples ranging from 300 to 2,000 nm; and in other examples ranging from 400 to 1,000 nm. The nanofibers 1308 may be fabricated such that their average fiber diameter is comparable to a wavelength λ of interest, such as that of the primary light emitted from a light source intended to irradiate the nanofiber substrate 1400. Sizing the nanofibers 1308 in this manner helps to provide scattering sites within the structure of the nanofiber substrate 1400 for the primary light or other wavelength λ of interest. For example, the wavelength λ of interest may range from 100 to 2,000 nm, or in a more specific example may range from 400 to 500 nm (e.g., a blue-emitting light source), or may fall within the shorter wavelength ranges corresponding to violet and UV light sources. The nanofiber substrate 1400 may be more effective in capturing photons having the shorter wavelengths typically utilized for excitation in that, on average, shorter-wavelength light may propagate through the nanofiber substrate 1400 over a longer optical path length (OPL).

For example, a typical excitation wavelength is blue light at 450 nm. To produce white light, the lighting device would need to emit radiation over a broad range of wavelengths, for example from 450 nm to 750 nm. By fabricating a nanofiber substrate 1400 in which the average diameter of the nanofibers 1308 is roughly the same as that of the excitation wavelength (e.g., 450 nm), the excitation light can be effectively trapped in the structure of the nanofiber substrate 1400 by light scattering (i.e., the OPL of the excitation light is long). This increases the likelihood that the excitation source will initiate fluorescence of the luminescent particles 1312 on or in the nanofiber substrate 1400 sufficient to cause the lighting device to produce white light that is uniform and has a balanced spectral power distribution. In contrast to the excitation light, the longer wavelength emissions produced by fluorescence may be scattered less effectively by the nanofibers 1308 and thus be more likely to emerge from the nanofiber substrate 1400 with minimal scattering. Under these conditions, the light scattering/photonic properties as a function of wavelength and fiber diameter are improved.

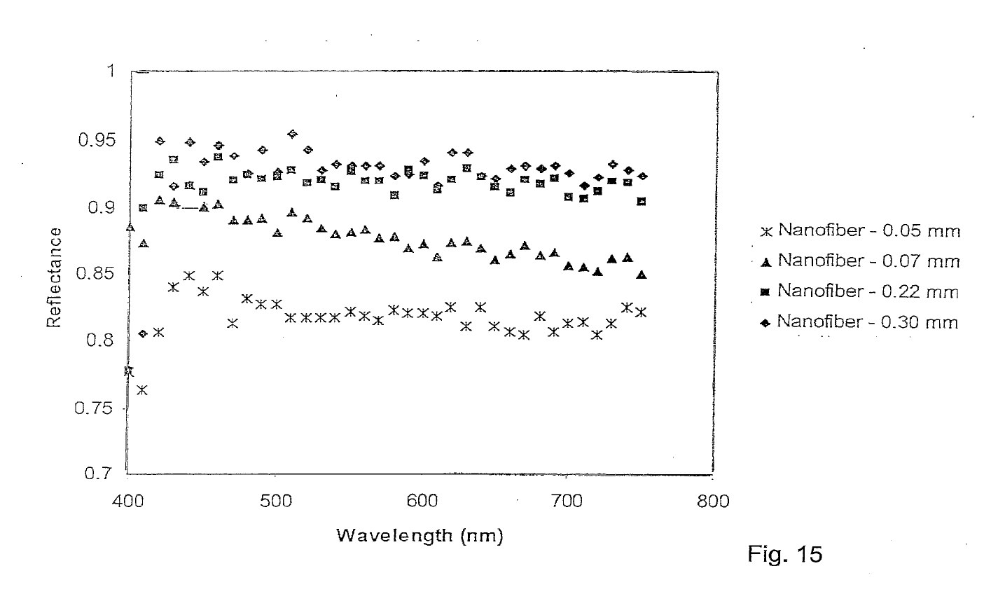

Additionally, the thickness of the nanofiber substrate 1400 may be selected to control the degree to which the nanofiber substrate 1400 is reflective of or (partially) transparent to light at wavelengths of interest. Generally, increasing thickness increases reflectivity and decreasing thickness increases transparency. In some examples, the thickness of the nanofiber substrate 1400 ranges from 0.1 to 2,000 μm. Thicknesses below 0.1 μm or above 2,000 μm are also encompassed by the present teachings, although an overly thin substrate 1400 may not be as effective at capturing incident excitation light while an overly thick substrate 1400 may promote too much scattering away from the particles 1312. In other examples, the thickness of the nanofiber substrate 1400 ranges from 1 to 500 μm. In some implementations, a thickness of greater than 5 μm will render the nanofiber substrate 1400 sufficiently diffusively reflective of light over the range of visible wavelengths processed by the lighting devices taught herein (i.e., primary light, secondary light, and auxiliary light). In some examples, the nanofiber substrate 1400 reflects greater than 80% of visible light. In other examples, the nanofiber substrate 1400 reflects greater than 90% of visible light, and may reflect almost 100% of visible light. FIG. 15 provides reflectance data measured as a function of wavelength for four samples of nanofiber substrates of different thicknesses (0.05 mm, 0.07 mm, 0.22 mm, and 0.30 mm). FIG. 15 demonstrates that reflectance of relatively thick nanofiber substrates may approach or exceed 95% over a broad spectrum of wavelengths. On the other hand, at thicknesses less than 5 μm the nanofiber substrate 1400 may be transparent to visible light of various wavelengths to an appreciable degree.

The nanofiber substrate 1400 may be fabricated by a variety of techniques. In some implementations, the method entails forming nanofibers 1308 of a controlled diameter by a technique such as electrospinning, extrusion, drawing, melt blowing, splitting/dissolving of bicomponent fibers, phase separation, solution spinning, flash spinning, template synthesis, or self-assembly. The method for fabricating the nanofiber substrate 1400 may be included as part of the methods described herein for fabricating color tuning materials and/or PL materials utilized as light converters.

In some advantageous implementations, the nanofibers 1308 are formed by an electrospinning technique. As appreciated by persons skilled in the art, a typical electrospinning apparatus may generally include a source (e.g., reservoir) of a polymer solution or melt utilized as a precursor to the nanofibers 1308. Various mixtures of polymers, solvents and additives may be utilized. The solvents may be organic or inorganic. Examples of solvents include, but are not limited to, distilled water, dimethylformamide, acetic acid, formic acid, dimethyl acetamide, toluene, methylene chloride, acetone, dichloromethane, combinations of the foregoing, one or more of the foregoing in combination with other solvents, or other suitable solvents. Additives may include viscosifiers, surfactants and the like. The polymer solution is flowed by any suitable means (e.g., a pump) to an electrospinning element (e.g., a head, needle, etc.). A positive electrode of a high-voltage power supply may be connected to the tip of the electrospinning element. The electrospinning element may be positioned at a specified distance from a metallic collector plate, which typically is electrically grounded. The electrospinning element and the collector plate may be located in a chamber configured to enable control over various processing conditions such as composition of gases, partial pressures, temperature, electrical field distribution, etc. With flow of the polymer solution at a specified flow rate established to the electrospinning element and a voltage of a specified magnitude applied to the electrospinning element, polymer nanofibers are drawn from the electrospinning element and accumulate as a nonwoven substrate on the collector plate. As appreciated by persons skilled in the art, the optimum operating parameters of the electrospinning apparatus (e.g., flow rate, voltage, distance between electrospinning element and collector plate, etc.) will depend on the composition of the nanofibers to be produced.

The general design, theory and operation of this type of electrospinning apparatus is known to persons skilled in the art and thus need not be described in detail herein. Some examples of suitable electrospinning apparatus and associated electrospinning-based techniques for forming nanofibers include those disclosed in U.S. Patent Application Pub. No. 2005/0224998; U.S. Patent Application Pub. No. 2005/0224999; U.S. Patent Application Pub. No. 2006/0228435; U.S. Patent Application Pub. No. 2006/0264140; U.S. Patent Application Pub. No. 2008/0110342; U.S. Patent Application Pub. No. 2008/0113214; International Pub. No. WO 2009/032378; and PCT Application No. PCT/US2010/031058.

In some implementations, electrospinning or other fiber-forming techniques may be utilized to produce a nanofiber substrate 1400 containing fibers of two or more average diameters. Fibers of different diameters may be mixed throughout the bulk of the nanofiber substrate 1400, or larger-diameter fibers may be located at one face of the nanofiber substrate 1400 while smaller-diameters are located at the opposite face. Fiber diameter may be graded through the thickness of the nanofiber substrate 1400.

In typical implementations, the nanofibers 1308 of the nanofiber substrate 1400 are polymers. Examples of suitable polymers include, but are not limited to, acrylonitrile/butadiene copolymer, cellulose, cellulose acetate, chitosan, collagen, DNA, fibrinogen, fibronectin, nylon, poly(acrylic acid), poly(chloro styrene), poly(dimethyl siloxane), poly(ether imide), poly(ether sulfone), poly(ethyl acrylate), poly(ethyl vinyl acetate), poly(ethyl-co-vinyl acetate), poly(ethylene oxide), poly(ethylene terephthalate), poly(lactic acid-co-glycolic acid), poly(methacrylic acid) salt, poly(methyl methacrylate), poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl acetate), poly(vinyl alcohol), poly(vinyl chloride), poly(vinylidene fluoride), polyacrylamide, polyacrylonitrile, polyamide, polyaniline, polybenzimidazole, polycaprolactone, polycarbonate, poly(dimethylsiloxane-co-polyethyleneoxide), poly(etheretherketone), polyethylene, polyethyleneimine, polyimide, polyisoprene, polylactide, polypropylene, polystyrene, polysulfone, polyurethane, poly(vinylpyrrolidone), proteins, SEBS copolymer, silk, and styrene/isoprene copolymer.

Additionally, the nanofibers 1308 may include a polymer blend. If electrospinning is to be implemented, the two or more polymers should be soluble in a common solvent or in a system of two or more appropriately selected solvents. Examples of suitable polymer blends include, but are not limited to, poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend-poly(vinylpyrrolidone), poly(hydroxybutyrate)-blend-poly(ethylene oxide), protein-blend-polyethyleneoxide, polylactide-blend-polyvinylpyrrolidone, polystyrene-blend-polyester, polyester-blend-poly(hyroxyethyl methacrylate), poly(ethylene oxide)-blend-poly(methyl methacrylate), and poly(hydroxystyrene)-blend-poly(ethylene oxide).

As noted above, in some implementations luminescent and/or reflective particles may be provided with the nanofibers 1308 prior to the nanofiber substrate 1400 being formed. In this manner light-stimulable fibers are formed, which thereafter may be collected and formed into a light-stimulable nanofiber substrate 1400. In one implementation, the particles 1312 may be applied (added) to the polymer solution supplied to the electrospinning apparatus and thus are discharged with the polymer matrix during electrospinning. The ratio of polymer to luminescent compound in the solution may typically range from 2:1 to 100:1. The large surface area of the nanofibers 1308 may be sufficient to prevent agglomeration of the particles 1312, although additional steps may be taken to inhibit agglomeration such as including de-agglomerating additives in the polymer/particle matrix, or other techniques disclosed in one or more of the references cited in the present disclosure. In another implementation, the particles 1312 are applied to an as-forming nanofiber (which at this stage may be in the form of a liquid jet, filament, proto-fiber, etc.) while the nanofiber is being electrospun and/or coalescing into a resultant fiber mat or substrate 1400. In this case, the particles 1312 may be transported to the as-forming nanofibers before they are dried by any suitable technique. In one advantageous implementation, a particle-inclusive solution is discharged from an electrospray apparatus positioned between the elecrospinning element and the collector plate. The position of the electrospay apparatus may be selected to control the extent of penetration of the particles 1312 into the nanofiber 1308, thereby dictating whether the particles 1312 become embedded in the bulk of the nanofiber 1308 (e.g., FIG. 13A) or disposed on the outer surface of the nanofiber 1308 (e.g., FIG. 13B). The electrospray apparatus may be effective in inhibiting agglomeration of the particles 1312.

In other implementations, the particles 1312 are applied after electrospinning, i.e., after the nanofibers 1308 have been formed into a nanofiber substrate 1400, by the various coating, printing and other methods described earlier in the present disclosure.

As noted previously, the particles 1312 may be luminescent particles such as QDs, phosphors, nano-phosphors, organic dyes, or combinations of two or more of the foregoing. Reflective particles may also be included, such as barium sulfate, titanium (IV) oxide, alumina, zinc oxide, Teflon®, and combinations of two or more of the foregoing.

Examples of light-emitting QDs include, but are not limited to, silicon, germanium, indium phosphide, indium gallium phosphide, cadmium sulfide, cadmium selenide, lead sulfide, copper oxide, copper selenide, gallium phosphide, mercury sulfide, mercury selenide, zirconium oxide, zinc oxide, zinc sulfide, zinc selenide, zinc silicate, titanium sulfide, titanium oxide, and tin oxide. In certain specific examples, QDs found to be particularly suitable include CdSe, InGaP, InP, GaP, and ZnSe. More generally, the QDs are typically composed of inorganic semiconductor materials selected from various Group II-VI, Group I-III-VI, Group III-V, Group IV, Group IV-VI, and Group V-VI materials. For some implementations, the QDs utilized may be selected from a class specified as being heavy metal-free (or restricted metal-free) QDs. Heavy metal-free QDs do not include heavy metals such as cadmium, mercury, lead, hexavalent chromium, or the like.

As other examples, QDs having the following compositions may be found to produce suitable secondary emissions of desired wavelengths in response to excitation of primary light of the wavelengths contemplated herein: Group II-VI materials such as ZnS, ZnSe, ZnTe, ZnO, CdS, CdSe, CdTe, CdO, HgS, HgSe, HgTe, HgO, MgS, MgSe, MgTe, MgO, CaS, CaSe, CaTe, CaO, SrS, SrSe, SrTe, SrO, BaS, BaSe, BaTe, and BaO; Group materials such as CuInS₂, Cu(In,Ga)S₂, CuInSe₂, and Cu(In,Ga)Se₂; Group III-V materials such as MN, AlP, AlAs, AlSb, GaN, GaP, GaAs, GaSb, InN, InP, InAs, and InSb; Group IV materials such as Si, Ge, and C; Group IV-VI materials such as GeSe, PbS, PbSe, PbTe, PbO, SnSe, SnTe, and SnS; and Group V-VI materials such as Sb₂Te₃, Bi₂Te₃, and Bi₂Se₃. Transition metal compounds such as the oxides, sulfides, and phosphides of Fe, Ni, and Cu may also be applicable. Examples of QDs further encompass binary, ternary, quaternary, etc. alloys or compounds that include the foregoing species (e.g., SiGe, InGaAs, InGaN, InGaAsP, AlInGaP, etc.). Other QDs may include other types of semiconducting materials (e.g., certain organic and polymeric materials). For a QD having a core-shell structure, the shell may be composed of one of the foregoing species or other species, and the respective compositions of the core and the shell may be different. An example of a core-shell composition is CdSe—ZnS capped with organic ligands such as trioctylphosphine oxide (TOPO). Such core-shell structures are commercially available from Evident Technologies, Inc., Troy, N.Y.

As appreciated by persons skilled in the art, the composition selected for the QDs may be based on a desired property such as band gap energy or wavelength sensitivity. Moreover, the size or shape of the QDs may be selected to absorb or emit a desired wavelength of electromagnetic radiation when integrated with a nanofiber substrate or applied as a layer to other types of substrates. Generally for a given species of QD below a critical size, smaller sizes have larger band gaps and emit radiation at shorter (bluer) wavelengths while larger sizes have smaller band gaps and emit radiation at longer (redder) wavelengths. For example, CdSe nanoparticles of 2.8 nm nominal diameter emit green light at roughly 530 nm, whereas CdSe nanoparticles of 5.0 nm nominal diameter emit red light at roughly 625 nm. Additionally, the QDs utilized may include QDs of two or more different species (compositions) and/or two or more different specific sizes, as for example when fabricating a pattern of different PL materials. For example, a mixture or pattern of two or more different QDs may be selected so that the QDs emit different bands of visible electromagnetic radiation. Alternatively or additionally, more than one distinct QD layer or region of QDs may be provided, each having a different composition or size of QDs.

The QDs may be formed by various known techniques such as, for example, colloidal synthesis, plasma synthesis, vapor deposition, epitaxial growth, and nanolithography. The size, size distribution, shape, surface chemistry or other attributes of the QDs may be engineered or tuned to have desired properties (e.g., photon absorption and/or emission) by any suitable technique now known or later developed. In some implementations, QDs are provided in a solution of an organic carrier solvent such as anisole, octane, hexane, toluene, butylamine, etc., or in water, and with or without a matrix or host material, and are deposited to a desired thickness by any of the techniques disclosed herein. Alternatively, the QDs may be dispersed to a desired density or concentration in a matrix material, which may be composed of a polymer, sol-gel or other material that can easily form a film on the underlying target surface. Generally, the matrix material selected is one that does not impair luminescence or other desired performance parameters of the QDs.

Examples of phosphors and nano-phosphors include, but are not limited to, the following groups:

1. Rare-earth doped metal oxides such as Y₂O₃:Tb, Y₂O₃:Eu³⁺, Lu₂O₃:Eu³⁺, CaTiO₃:Pr³⁺, CaO:Er³⁺, (GdZn)O:Eu³⁺, Sr₄Al₁₄O₂₅:Eu³⁺, GdMbB₃O₁₀:Ce³⁺:Tb³⁺, and CeMgAl₁₁O₁₉:Ce³⁺:Tb³⁺;

2. Metal sulfides such as CaS:Eu²⁺, SrGa₂S₄:Eu, and Ca_{w}SrₓGa_{y}(S,Se)_{z}:Eu such as those described in U.S. Pat. No. 6,982,045 and commercially available from PhosphorTech (Lithia Springs, Ga.);

3. Rare-Earth doped yttrium aluminum garnet (YAG) such as YAG:Ce³⁺;

4. Metal silicates such as Ca₃(Sc,Mg)₂Si₃O₁₂:Ce and (Ba,Sr)₂SiO₄:Eu, and rare-Earth doped silicates including Eu-doped silicates;

5. Rare-earth doped zirconium oxide such as ZrO₂:Sm³⁺ and ZrO₂:Er³⁺;

6. Rare-earth doped vanadate (YVO₄:Eu) and phosphate (La,Ce,Tb)PO₄;

7. Doped materials consisting of a host matrix (e.g., Gd₂O₃, GdO₂S, PbO, ZnO, ZnS, ZnSe) and a dopant (Eu, Tb, Tm, Cu, Al and Mn); and

8. Metal-doped forms of zinc sulfide and zinc selenide (e.g., ZnS:Mn²⁺, ZnS:Cu⁺, Zn_{0.25}Cd_{0.75}S:AgCl).

Other examples of phosphors that may be suitable may be found in W. M. Yen, S. Shionoya, and H. Yamamoto, Phosphor Handbook, Second Ed., the entire contents of which are incorporated by reference herein. In certain specific examples, phosphors found to be particularly suitable include rare-earth doped YAG, doped metal sulfides including doped ZnS and doped SrGa₂S₄, doped ZnSe, and doped silicates such as those available from Internatix of Fremont, Calif.

Phosphors are typically provided in aqueous dispersions and may include a polymeric binder as well as any of the additives noted above. Generally, phosphors may be applied to underlying substrates or particle layers by employing the same coating, printing and other techniques as for QDs.

Examples of organic dyes include, but are not limited to, various proteins and small molecules that exhibit fluorescence; fluorophores, such as resonance dyes like fluoresceins, rhodamines; most 4,4′-difluoro-4-bora-3a,4a-diaza-s-indacenes (BODIPY dyes); most cyanines; and charge transfer dyes (emission from intramolecular charge transfer transitions) such as coumarins.

As described above, a PL material as taught herein may include a combination (e.g., a blend, pattern, etc.) of QDs, phosphors, nano-phosphors and/or dyes, including a distribution of different sized particles of one or more of the foregoing classes of luminescent materials, to provide secondary emission of two or more different wavelengths. For instance, a PL material may include green-emitting phosphors and red-emitting QDs. A combination of luminescent particles may be selected such that, in further combination with the wavelength of the portion of the primary light emitted by the light source that is included in the output light of the lighting device, the output light has a broad-spectrum composition of wavelengths approaching that of a blackbody radiator and accordingly characterized by a CRI value approaching 100.

The Table below provides some non-limiting examples of combinations of light sources and luminescent materials found to be suitable for producing white light in lighting devices such as those disclosed herein:

| Example | Light source | PL material |
|---|---|---|
| 1 | Blue LED, | CdSe/ZnS core-shell QDs (Evident |
| | 450-460 nm | Technologies), particle diameter 2.6-3.2 nm, |
| | | yellow emission, |
| 2 | Blue LED, | CdSe/ZnSe core-shell QDs (Evident |
| | 450-460 nm | Technologies): |
| | | particle diameter 2.4 nm, green emission; |
| | | and particle diameter 5.2 nm, red emission |
| 3 | Violet LED, | CdSe/ZnSe core-shell QDs (Evident |
| | 408 nm | Technologies) |
| | | particle diameter 1.9 nm, blue emission; |
| | | and particle diameter 2.4 nm, green emission; |
| | | and particle diameter 5.2 nm, red emission |
| 4 | UV LED, | CdSe/ZnSe core-shell QDs (Evident |
| | 350-370 nm | Technologies) |
| | | particle diameter 1.9 nm, blue emission; |
| | | and particle diameter 2.4 nm, green emission; |
| | | and particle diameter 5.2 nm, red emission |
| 5 | Blue LED, | Sulfoselenide phosphor (PhosphorTech |
| | 450-470 nm | Corp., Lithia Springs, GA), green emission; |
| | | and Red-emitting QDs |
| 6 | Blue LED, | Eu-doped silicate phosphor (Intematix |
| | 450-470 nm | Corp., Fremont, CA), green emission; |
| | | and Red-emitting QDs |
| 7 | Blue LED, | Ce-doped YAG phosphor (Intematix Corp., |
| | 450-470 nm | Fremont, CA), yellow emission; |
| | | and Red-emitting QDs |

It will be understood that in addition to lighting devices utilizing SSL lamps, the color tuning materials described herein may be added to lighting devices utilizing other types of light sources such as, for example, incandescent lamps (ILs) and fluorescent lamps (FLs). In these cases, the color tuning materials would typically be positioned at an appropriate location of a reflective cavity or housing provided with the IL or FL lighting device.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

For purposes of the present disclosure, it will be understood that when a layer (or film, region, substrate, component, device, or the like) is referred to as being “on” or “over” another layer, that layer may be directly or actually on (or over) the other layer or, alternatively, intervening layers (e.g., buffer layers, transition layers, interlayers, sacrificial layers, etch-stop layers, masks, electrodes, interconnects, contacts, or the like) may also be present. A layer that is “directly on” another layer means that no intervening layer is present, unless otherwise indicated. It will also be understood that when a layer is referred to as being “on” (or “over”) another layer, that layer may cover the entire surface of the other layer or only a portion of the other layer. It will be further understood that terms such as “formed on” or “disposed on” are not intended to introduce any limitations relating to particular methods of material transport, deposition, fabrication, surface treatment, or physical, chemical, or ionic bonding or interaction. The term “interposed” is interpreted in a similar manner.

The following references contain subject matter related to the present subject matter, and each reference is incorporated by reference herein in its entirety: U.S. Patent Application Pub. No. 2005/0224998, filed on Apr. 8, 2004, titled “Electrospray/electrospinning Apparatus and Method;” U.S. Patent Application Pub. No. 2005/0224999, filed Apr. 8, 2004, titled “Electrospinning in a Controlled Gaseous Environment;” U.S. Patent Application Pub. No. 2006/0228435, filed on Apr. 8, 2004, titled “Electrospinning of Polymer Nanofibers Using a Rotating Spray Head;” U.S. Patent Application Pub. No. 2006/0264140, filed May 17, 2005 titled “Nanofiber Mats and Production Methods Thereof;” U.S. Patent Application Pub. No. 2008/0110342, filed Nov. 13, 2006, titled “Particle Filter System Incorporating Nanofibers;” U.S. Patent Application Pub. No. 2008/0113214, filed on Nov. 13, 2006, titled “Luminescent Device;” International Pub. No. WO 2009/032378, filed on Jun. 12, 2008, titled “Long-Pass Optical Filter Made from Nanofibers;” U.S. Provisional Patent Application No. 61/266,323, filed on Dec. 3, 2009, titled “Reflective Nanofibers in Lighting Devices;” PCT Application No. PCT/US2010/031058, filed on Apr. 14, 2010, titled “Stimulated Lighting Devices;” U.S. Provisional patent application titled “Color-Tunable Lighting Devices and Methods for Tuning Color Output of Lighting Devices” Attorney Docket No. RTI10001USV, filed concurrently with the present application; U.S. Provisional patent application titled “Photoluminescent Nanofiber Composites, Methods for Fabrication, and Related Lighting Devices,” Attorney Docket No. RTI10002USV, filed concurrently with the present application; and U.S. Provisional patent application titled “Lighting Devices Utilizing Optical Waveguide and Remote Light Converters, and Related Methods,” Attorney Docket No. RTI10004USV, filed concurrently with the present application.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A lighting device, comprising:
a housing enclosing a housing interior and comprising a light exit for outputting a combination of primary light, secondary light, and auxiliary light;
a light source configured for emitting a primary light beam of a primary wavelength through the housing interior;
a light converter comprising a luminescent material facing the housing interior and configured for emitting secondary light of one or more wavelengths different from the primary wavelength, in response to excitation by the primary light beam; and
a color tuning material optically aligned with the light source and configured for emitting auxiliary light in response to incidence by the primary light beam.

2. The lighting device of claim 1, wherein the color tuning material comprises a reflective material such that the auxiliary light has a wavelength equal to the primary wavelength.

3. The lighting device of claim 1, wherein the color tuning material comprises a luminescent material configured for emitting the auxiliary light at one or more wavelengths different from the primary wavelength in response to excitation by the primary light beam.

4. The lighting device of claim 3, wherein the color tuning material is configured for emitting the auxiliary light at a wavelength equal to at least one wavelength of the secondary light, or at a wavelength different from at least one wavelength of the secondary light.

5. The lighting device of claim 3, wherein the color tuning material comprises two or more luminescent components configured for emitting auxiliary light components of two or more different wavelengths.

6. The lighting device of claim 1, wherein the color tuning material comprises a reflective material reflective of primary light and a luminescent material configured for emitting the auxiliary light at one or more wavelengths different from the primary wavelength in response to excitation by the primary light beam, such that the auxiliary light has a wavelength equal to the primary wavelength and one or more other wavelengths different from the primary wavelength.

7. The lighting device of claim 1, wherein the color tuning material is disposed on a portion of the luminescent material of the light converter, or between the light source and the luminescent material of the light converter.

8. The lighting device of claim 7, wherein the light source is optically aligned with the luminescent material of the light converter along a nominal output axis of the light source, and a central portion of the primary light beam centered about the nominal output axis irradiates the color tuning material, or irradiates an area of the light converter outside the color tuning material.

9. The lighting device of claim 7, comprising a substrate disposed on the portion of the luminescent material of the light converter or disposed between the light source and the luminescent material of the light converter, wherein the color tuning material is supported by the substrate.

10. The lighting device of claim 1, wherein the housing has an inside surface facing the housing interior and the color tuning material is disposed on a portion of the inside surface or between the light source and the inside surface.

11. The lighting device of claim 10, comprising a substrate disposed on the portion of the inside surface or disposed between the light source and the inside surface, wherein the color tuning material is supported by the substrate.

12. The lighting device of claim 10, wherein the inside surface is a reflective surface.

13. The lighting device of claim 1, comprising a substrate, wherein the color tuning material is supported by the substrate.

14. The lighting device of claim 13, wherein the substrate comprises a plurality of nanofibers.

15. A method for tuning a color of output light produced by a lighting device, the lighting device comprising a housing interior, a light exit, a light source, and a light converter, the method comprising:
outputting output light from the light exit by emitting primary light of a primary wavelength from the light source through the housing interior, wherein the light converter emits secondary light through the housing interior in response to excitation by the primary light, the secondary light has one or more wavelengths different than the primary wavelength, and the output light comprises a combination of the primary light and the secondary light; and
adjusting a color parameter of the output light by adding a color tuning material at a location in the housing interior where primary light is incident on the color tuning material, the color tuning material being configured for emitting auxiliary light in response to the incident primary light, wherein subsequent operation of the lighting device produces color-tuned output light comprising a combination of the primary light, the secondary light and the auxiliary light.

16. The method of claim 15, wherein the adjusted color parameter is selected from the group consisting of radiant flux at one or more wavelengths, color rendering index, correlated color temperature, chromaticity coordinate, distance from Planckian locus, and combinations of two or more of the foregoing.

17. The method of claim 15, wherein emitting primary light comprises directly striking the light converter with at least a portion of the emitted primary light, and adjusting the color parameter comprises adding the color tuning material at a location where at least some of the primary light portion directly strikes the color tuning material instead of the light converter.

18. The method of claim 15, wherein adjusting the color parameter comprises positioning the color tuning material on the light converter, or between the light source and the light converter, such that at least some of the primary light that was directly incident on the light converter before adjusting is, after adjusting, directly incident on the color tuning material.

19. The method of claim 15, wherein emitting primary light comprises directly striking an inside surface in the housing interior with at least a portion of the emitted primary light, and adjusting the color parameter comprises adding the color tuning material at a location where at least some of the primary light portion directly strikes the color tuning material instead of the inside surface.

20. The method of claim 15, wherein adjusting the color parameter comprises positioning the color tuning material on an inside surface in the housing interior, or between the light source and the inside surface, such that at least some of the primary light that was directly incident on the inside surface before adjusting is, after adjusting, directly incident on the color tuning material.

21. The method of claim 15, comprising selecting a configuration of the color tuning material, wherein the configuration is selected from the group consisting of: a position of the color tuning material in the housing interior; a composition of the color tuning material that determines a wavelength at which the color tuning material emits auxiliary light; and both the position and the composition.

22. The method of claim 15, comprising selecting a composition of the color tuning material, wherein the composition is selected from the group consisting of: a reflector of the primary light; one or more luminescent emitters of auxiliary light at one or more respective wavelengths different from the primary wavelength; and both a reflector and one or more luminescent emitters.

23. The method of claim 15, wherein adjusting the color parameter comprises applying a solution to the light converter or to an inside surface in the housing interior, and the solution is selected from the group consisting of a solution comprising reflective particles, a solution comprising luminescent particles, and a solution comprising both reflective particles and luminescent particles.

24. The method of claim 23, wherein applying the solution to the light converter or the inside surface comprises applying the solution to a substrate and positioning the substrate on the light converter or the inside surface.

25. The method of claim 15, wherein adjusting the color parameter comprises removing a component from the lighting device, applying a solution to the component, and reinstalling the component at the lighting device, and the solution is selected from the group consisting of a solution comprising reflective particles, a solution comprising luminescent particles, and a solution comprising both reflective particles and luminescent particles.

26. The method of claim 15, comprising measuring the color parameter while outputting the output light to acquire a measured value, wherein adjusting the color parameter adjusts the measured value to a new value closer or equal to a desired value.

27. The method of claim 26, comprising, after adjusting the color parameter, measuring the new value and determining whether a difference between the new value and the desired value is in a desired range, and if not, performing one or more iterations of adjusting the color parameter, measuring the color parameter, and determining the difference between the new value and the desired value.

28. A method for tuning a color of output light produced by a lighting device, the lighting device comprising a housing interior, a light exit, a light source, and a light converter, the method comprising:
evaluating output light emanating from the light exit and produced by emitting primary light of a primary wavelength from the light source through the housing interior, wherein the light converter emits secondary light through the housing interior in response to excitation by the primary light, the secondary light has one or more wavelengths different than the primary wavelength, and the output light comprises a combination of the primary light and the secondary light;
determining whether the color of the output light should be tuned; and
if it is determined that the color of the output light should be tuned, adding a color tuning material at a location in the housing interior where primary light is incident on the color tuning material, the color tuning material being configured for emitting auxiliary light in response to the incident primary light, wherein after tuning the color the lighting device produces color-tuned output light in which the auxiliary light is combined with the primary light and the secondary light.

29. The method of claim 28, wherein evaluating comprises measuring a color parameter of the output light, and tuning comprises adjusting the color parameter.
